(19) United States
(12) Patent Application Publication
(10) Pub. No.: US 2025/0008269 A1
(43) Pub. Date: Jan. 2, 2025

(54) DUAL-DIAPHRAGM SPEAKER AND ELECTRONIC DEVICE

(71) Applicant: HUAWEI TECHNOLOGIES CO., LTD., Shenzhen, Guangdong (CN)

(72) Inventors: Haohao ZHANG, Dongguan (CN); Ling TAO, Dongguan (CN); Mingguang GUO, Dongguan (CN)

(21) Appl. No.: 18/292,820

(22) PCT Filed: Jul. 20, 2022
(86) PCT No.: PCT/CN2022/106799

§ 371 Date: Jan. 26, 2024

(30) Foreign Application Priority Data
Jul. 30, 2021 (CN) 202110873633.3

(51) Int. Cl. H04R 9/02; H04R 1/22; H04R 7/04; H04R 9/04; H04R 9/06

(52) U.S. Cl. CPC H04R 9/025; H04R 1/22; H04R 7/04; H04R 9/045; H04R 9/06

(57) ABSTRACT

This application provides a speaker and an electronic device. The speaker includes a ring-shaped housing, a magnetic circuit system, a first diaphragm disposed at a first end of the ring-shaped housing, a first component, a first voice coil, a second diaphragm, a second component, and a second voice coil, a first channel, and the first channel is located in at least one of the magnetic circuit system and the ring-shaped housing. The dual-diaphragm speaker in embodiments of this application has a small volume, and can improve low- and medium-frequency sensitivity.

### CROSS-REFERENCE TO RELATED APPLICATIONS

This application is a national stage of International Application No. PCT/CN2022/106799, filed on Jul. 20, 2022, which claims priority to Chinese Patent Application No. 202110873633.3, filed on Jul. 30, 2021. Both of the aforementioned applications are hereby incorporated by reference in their entireties.

### TECHNICAL FIELD

This application relates to the electroacoustic field, and in particular, to a dual-diaphragm speaker and an electronic device.

### BACKGROUND

An in-ear earphone has advantages such as good airtightness and sound insulation, good sound quality, and no sound leakage, but wearing the in-ear earphone causes ear strain or pain, and most importantly, the stethoscope effect (that is, a mechanical wave generated by external collision or air friction at an earbud cable or unit is directly transmitted to an ear canal through the earbud cable, which causes unpleasant noise, and the in-ear cable is usually hard and conducive to conducting vibration). However, a semi-in-ear earphone is popular with most consumers because the semi-in-ear earphone has a semi-open architecture, does not have the stethoscope effect, and is comfortable to wear. However, due to a leaky architecture of the semi-in-ear earphone, leakage of a low- and medium-frequency sound wave (including a low- and medium-frequency signal in a target signal and/or a low- and medium-frequency signal in a noise cancelling signal) is large, which makes low- and medium-frequency performance of the semi-in-ear earphone poor. For example, low- and medium-frequency effect is poor when music is played, or an active noise canceling (ANC) function has poor noise canceling effect on low- and medium-frequency noise.

Currently, a solution to this problem is to increase low- and medium-frequency sensitivity (speaker sensitivity refers to a sound pressure level generated at a distance of 1 m from a speaker axis when an electrical signal with rated power of 1 W is added to an input end of the speaker, which reflects efficiency of converting electric energy into sound energy, and higher sensitivity indicates a higher probability that the speaker is driven by a power amplifier) of a speaker. However, an existing speaker may increase in volume while the low- and medium-frequency sensitivity is improved and cannot be applied to a miniaturized electronic device or save space, which is not conducive to better meeting a user requirement. Therefore, how to implement a speaker and an earphone with high low- and medium-frequency sensitivity and miniaturization becomes a problem to be urgently resolved currently.

### SUMMARY

Embodiments of this application provide a dual-diaphragm speaker and an electronic device. Sound wave transfer paths of front cavities and rear cavities of two diaphragms are respectively separated, to avoid a sound short circuit. In addition, sound wave superimposition and high sound pressure can be further implemented while a small volume is ensured. Low- and medium-frequency performance is enhanced, and low- and medium-frequency sensitivity is further improved.

Therefore, the following technical solutions are used in embodiments of this application.

According to a first aspect, an embodiment of this application provides a dual-diaphragm speaker. The dual-diaphragm speaker includes a ring-shaped housing; a magnetic circuit system, disposed in the ring-shaped housing and dividing space in the ring-shaped housing into a first cavity and a second cavity in a direction of a principal axis of the ring-shaped housing, where the magnetic circuit system includes a first magnetic gap and a second magnetic gap disposed at a spacing around the principal axis; a first diaphragm, disposed at a first end of the ring-shaped housing, to form a first front cavity with the first cavity, and configured to form a first rear cavity with a first component on a side surface that is of the first diaphragm and that is away from the magnetic circuit system; a first voice coil, disposed in the first front cavity, where one end of the first voice coil is connected to the first diaphragm, and the other end of the first voice coil extends into the first magnetic gap; a second diaphragm, disposed at a second end of the ring-shaped housing, to form a second rear cavity with the second cavity, and configured to form a second front cavity with a second component on a side surface that is of the second diaphragm and that is away from the magnetic circuit system, where the second rear cavity is not in communication with the first front cavity; and a second voice coil, disposed in the second rear cavity, where one end of the second voice coil is connected to the second diaphragm, and the other end of the second voice coil extends into the second magnetic gap, where the first front cavity communicates with the second front cavity through at least one first channel, and the first channel is located in at least one of the magnetic circuit system and the ring-shaped housing; and the second rear cavity is closed, or the second rear cavity communicates with the first rear cavity or the atmosphere through at least one second channel.

The first channel may be located on at least one of an outer peripheral wall of the magnetic circuit system and an inner wall of the ring-shaped housing or within a housing wall of the ring-shaped housing.

A high-frequency sound wave is not prone to a short circuit and a low- and medium-frequency sound wave has a long wavelength and is prone to the short circuit, and the short circuit reduces low- and medium-frequency sound pressure and causes an acoustic performance loss. Therefore, in an embodiment of the application, sound wave transfer paths of the front cavities and the rear cavities of the two diaphragms are respectively separated, so that a sound short circuit can be avoided. When sound wave superimposition is performed, the low- and medium-frequency sound wave (including low and medium frequencies of a target signal and/or low and medium frequencies of a noise canceling signal) can be improved, low- and medium-frequency sensitivity of the speaker is improved, good low- and medium-frequency noise canceling effect is achieved, and/or the low and medium frequencies of the target signal is enhanced. In addition, communication between the first front cavity and the second front cavity is implemented through the first channel located on the inner side or inside the ring-shaped housing, which facilitates a connection to a sound output pipe of an electronic device. Compared with a solution in which a pipe is disposed outside the ring-shaped housing to connect the first front cavity and the second front cavity, this reduces a volume and is conducive to achieving miniaturization. In addition, because the diaphragm can be disposed on an end surface of the ring-shaped housing, an area of the diaphragm is large, more air is pushed, and sound pressure is high, which can further improve the low- and medium-frequency sensitivity of the speaker.

In an embodiment, an outer peripheral wall of the magnetic circuit system is in a sealed connection to an inner wall of the ring-shaped housing, an outer peripheral edge of the second diaphragm is in a sealed connection to the magnetic circuit system, and the first channel includes a first opening groove disposed on the inner wall of the ring-shaped housing and/or on the outer peripheral wall of the magnetic circuit system; and the first diaphragm is in a sealed connection to an entire end surface of the first end of the ring-shaped housing, and the first opening groove extends from the first front cavity to an end surface of the second end of the ring-shaped housing; or the first diaphragm is in a sealed connection to the magnetic circuit system, a first notch communicating with the front cavity is disposed on the magnetic circuit system, the first channel further includes the first notch, and the first opening groove extends from the first notch to an end surface of the second end of the ring-shaped housing. In an embodiment, the first channel can be formed by disposing the opening groove on the inner wall of the ring-shaped housing, by disposing the opening groove on the outer peripheral wall of the magnetic circuit system, or by respectively disposing opening grooves on the inner wall of the ring-shaped housing and on the outer peripheral wall of the magnetic circuit system. In this case, the first diaphragm can be in the sealed connection to the ring-shaped housing or the magnetic circuit system, and the second diaphragm can be in the sealed connection to the magnetic circuit system.

In an embodiment, the second rear cavity communicates with the first rear cavity or the atmosphere through the second channel, and a second notch communicating with the second rear cavity is disposed on the magnetic circuit system; and the second channel includes a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or the first diaphragm is in a sealed connection to the magnetic circuit system, the second channel includes the second notch and a second opening groove disposed on the inner wall of the ring-shaped housing and/or on the outer peripheral wall of the magnetic circuit system, and the second opening groove extends from the second notch to an end surface of the first end of the ring-shaped housing. In an embodiment, the second rear cavity can communicate with the atmosphere through the second channel, or the second rear cavity can communicate with the first rear cavity through the second channel, to increase a volume of the rear cavity, so that a vibration amplitude of a corresponding diaphragm can be increased and high sound pressure is formed. This helps improve low- and medium-frequency sensitivity of the speaker. In addition, the second opening groove can be formed by disposing the opening groove on the inner wall of the ring-shaped housing, by disposing the opening groove on the outer peripheral wall of the magnetic circuit system, or by respectively disposing opening grooves on the inner wall of the ring-shaped housing and on the outer peripheral wall of the magnetic circuit system.

In an embodiment, a first ring-shaped boss is disposed on an inner wall of the first end of the ring-shaped housing, the first diaphragm is in a sealed connection to the first ring-shaped boss, the magnetic circuit system is connected to a side surface that is of the first ring-shaped boss and that is away from the first diaphragm, an outer peripheral wall of the magnetic circuit system is in a sealed connection to an inner wall of the ring-shaped housing, an outer peripheral edge of the second diaphragm is in a sealed connection to the magnetic circuit system, a first notch communicating with the first front cavity is disposed on at least one of the first ring-shaped boss and the magnetic circuit system, the first channel includes the first notch and a first opening groove disposed on the inner wall of the ring-shaped housing and/or on the outer peripheral wall of the magnetic circuit system, and the first opening groove extends from the first notch to an end surface of the second end of the ring-shaped housing. In an embodiment, the first ring-shaped boss is disposed, to facilitate positioning and mounting of the magnetic circuit system and to prevent the magnetic circuit system from moving in an axial direction of the ring-shaped housing.

In an embodiment, the second rear cavity communicates with the first rear cavity or the atmosphere through the second channel, and a second notch communicating with the second rear cavity is disposed on the magnetic circuit system; and the second channel includes a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or the second channel includes the second notch and a second opening groove disposed on the inner wall of the ring-shaped housing and/or on the outer peripheral wall of the magnetic circuit system, and the second opening groove extends from the second notch to an end surface of the first end of the ring-shaped housing and penetrates the first ring-shaped boss. In an embodiment, the second rear cavity can communicate with the atmosphere through the second channel, or the second rear cavity can communicate with the first rear cavity through the second channel, to increase a volume of the rear cavity, so that a vibration amplitude of a corresponding diaphragm can be increased and high sound pressure is formed. This helps improve low- and medium-frequency sensitivity of the speaker.

In an embodiment, a second ring-shaped boss is disposed on an inner wall of the second end of the ring-shaped housing, the second diaphragm is in a sealed connection to the second ring-shaped boss, the magnetic circuit system is connected to a side surface that is of the second ring-shaped boss and that is away from the second diaphragm, and the first channel includes a first opening groove disposed on an inner wall of the ring-shaped housing and/or on an outer peripheral wall of the magnetic circuit system; and the first diaphragm is in a sealed connection to an entire end surface of the first end of the ring-shaped housing, and the first opening groove extends from the first front cavity to an end surface of the second end of the ring-shaped housing and penetrates the second ring-shaped boss; or the first diaphragm is in a sealed connection to the magnetic circuit system, a first notch communicating with the front cavity is disposed on the magnetic circuit system, the first channel further includes the first notch, and the first opening groove extends from the first notch to an end surface of the second end of the ring-shaped housing. In an embodiment, the second ring-shaped boss is disposed, to facilitate positioning and mounting of the magnetic circuit system and to prevent the magnetic circuit system from moving in an axial direction of the ring-shaped housing.

In an embodiment, the second rear cavity communicates with the first rear cavity or the atmosphere through the second channel, and a second notch communicating with the second rear cavity is disposed on at least one of the second ring-shaped boss and the magnetic circuit system; and the second channel includes a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or the first diaphragm is in a sealed connection to the magnetic circuit system, the second channel includes the second notch and a second opening groove disposed on the inner wall of the ring-shaped housing and/or on the outer peripheral wall of the magnetic circuit system, and the second opening groove extends from the second notch to an end surface of the first end of the ring-shaped housing. In an embodiment, the second rear cavity can communicate with the atmosphere through the second channel, or the second rear cavity can communicate with the first rear cavity through the second channel, to increase a volume of the rear cavity, so that a vibration amplitude of a corresponding diaphragm can be increased and high sound pressure is formed. This helps improve low- and medium-frequency sensitivity of the speaker.

In an embodiment, a first ring-shaped boss is disposed on an inner wall of the first end of the ring-shaped housing, a second ring-shaped boss is disposed on an inner wall of the second end of the ring-shaped housing, the magnetic circuit system is connected between the first ring-shaped boss and the second ring-shaped boss, an outer peripheral wall of the magnetic circuit system is in a sealed connection to an inner wall of the ring-shaped housing, an outer peripheral edge of the first diaphragm is in a sealed connection to the first ring-shaped boss, and an outer peripheral edge of the second diaphragm is in a sealed connection to the second ring-shaped boss; and a first notch communicating with the first front cavity is disposed on at least one of the first ring-shaped boss and the magnetic circuit system, the first channel includes the first notch and a first opening groove disposed on the inner wall of the ring-shaped housing and/or on the outer peripheral wall of the magnetic circuit system, and the first opening groove extends from the first notch to an end surface of the second end of the ring-shaped housing and penetrates the second ring-shaped boss. In an embodiment, the first ring-shaped boss and the second ring-shaped boss are disposed, to facilitate positioning and mounting of the magnetic circuit system and to prevent the magnetic circuit system from moving in an axial direction of the ring-shaped housing.

In an embodiment, the second rear cavity communicates with the first rear cavity or the atmosphere through the second channel, and a second notch communicating with the second rear cavity is disposed on at least one of the second ring-shaped boss and the magnetic circuit system; and the second channel includes a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or the second channel includes the second notch and a second opening groove disposed on the inner wall of the ring-shaped housing and/or on the outer peripheral wall of the magnetic circuit system, and the second opening groove extends from the second notch to an end surface of the first end of the ring-shaped housing and penetrates the first ring-shaped boss. In an embodiment, the second rear cavity can communicate with the atmosphere through the second channel, or the second rear cavity can communicate with the first rear cavity through the second channel, to increase a volume of the rear cavity, so that a vibration amplitude of a corresponding diaphragm can be increased and high sound pressure is formed. This helps improve low- and medium-frequency sensitivity of the speaker.

In an embodiment, an outer peripheral wall of the magnetic circuit system is in a sealed connection to an inner peripheral wall of the ring-shaped housing, the first channel includes a first through hole disposed on the magnetic circuit system or the ring-shaped housing, and one end of the first through hole is connected to the first front cavity, and the other end of the first through hole extends to an end surface of the second end of the ring-shaped housing. In an embodiment, the first channel can be formed by disposing the through hole on a housing wall of the ring-shaped housing or by disposing the through hole on the magnetic circuit system. In this case, the first diaphragm can be in the sealed connection to the ring-shaped housing or the magnetic circuit system, and the second diaphragm can be in the sealed connection to the ring-shaped housing or the magnetic circuit system.

In an embodiment, the second rear cavity communicates with the first rear cavity or the atmosphere through the second channel, the outer peripheral wall of the magnetic circuit system is in a sealed connection to the inner peripheral wall of the ring-shaped housing, the second channel includes a second through hole disposed on the magnetic circuit system or the ring-shaped housing, and a first end of the second through hole communicates with the second rear cavity, and the other end of the second through hole extends to the end surface of the first end of the ring-shaped housing or to an outer peripheral wall of the ring-shaped housing. In an embodiment, the second channel can be formed by disposing the through hole on a housing wall of the ring-shaped housing or by disposing the through hole on the magnetic circuit system. In this case, the first diaphragm can be in the sealed connection to the ring-shaped housing or the magnetic circuit system, and the second diaphragm can be in the sealed connection to the ring-shaped housing or the magnetic circuit system.

In an embodiment, the first ring-shaped boss is disposed on the inner wall of the first end of the ring-shaped housing, and the magnetic circuit system is in a sealed connection to the first ring-shaped boss on the side surface that is of the first ring-shaped boss and that is away from the first diaphragm; and/or the second ring-shaped boss is disposed on the inner wall of the second end of the ring-shaped housing, and the magnetic circuit system is in a sealed connection to the second ring-shaped boss on the side surface that is of the second ring-shaped boss and that is away from the second diaphragm. In an embodiment, the first ring-shaped boss and the second ring-shaped boss are disposed, to facilitate positioning and mounting of the magnetic circuit system and to prevent the magnetic circuit system from moving in an axial direction of the ring-shaped housing. In this case, the first diaphragm can be in the sealed connection to the first ring-shaped boss, and the second diaphragm can be in the sealed connection to the second ring-shaped boss.

In an embodiment, more than two first channels are disposed in the dual-diaphragm speaker, and the more than two first channels are disposed at a spacing in a circumferential direction of the ring-shaped housing. In this way, the first channel is evenly disposed, sound made is good, and force applied to the ring-shaped housing is balanced.

In an embodiment, more than two second channels are disposed in the dual-diaphragm speaker, and the more than two second channels are disposed at a spacing in a circumferential direction of the ring-shaped housing. In this way, the second channel is evenly disposed, sound made is good, and force applied to the ring-shaped housing is balanced.

In an embodiment, a positioning boss is disposed on an outer peripheral wall of the ring-shaped housing, a plurality of through holes communicating with an inner side and an outer side of the ring-shaped housing are disposed on the positioning boss, a first voice coil line is disposed on the first voice coil, a second voice coil line is disposed on the second voice coil, the first voice coil line and the second voice coil line are respectively electrically connected to a power amplifier apparatus through the plurality of through holes, and the positioning boss and the at least one first channel or the at least one second channel are disposed at a spacing in a circumferential direction of the ring-shaped housing. In an embodiment, the positioning boss may be configured to position and mount the dual-diaphragm speaker to an electronic device, and a structure that enables the voice coil line to communicate with an external circuit may be disposed at the positioning boss, for example, the through hole or an embedded metal soldering pad that are connected to the inner side and the outer side of the ring-shaped housing. In this way, the voice coil line may be connected to the external circuit through the through hole, or the voice coil line may be connected to the metal soldering pad in the ring-shaped housing, and the metal soldering pad is connected to the external circuit. In addition, the positioning boss and the channel are disposed at the spacing in the circumferential direction of the ring-shaped housing, so that sound wave conduction is even, a structure design is reasonable, and force is balanced.

In an embodiment, the ring-shaped housing includes a first housing and a second housing disposed in the direction of the principal axis; and a first ring-shaped step is disposed on an end surface of an end that is of the first housing and that is away from the second housing, a first ring-shaped mounting part is disposed on the outer peripheral edge of the first diaphragm, and the first ring-shaped mounting part is disposed at the first ring-shaped step, to implement a sealed connection between the outer peripheral edge of the first diaphragm and the end surface of the first end of the ring-shaped housing; and/or a second ring-shaped step is disposed on an end surface of an end that is of the second housing and that is away from the first housing, a second ring-shaped mounting part is disposed on the outer peripheral edge of the second diaphragm, and the second ring-shaped mounting part is disposed at the second ring-shaped step, to implement a sealed connection between the outer peripheral edge of the second diaphragm and the end surface of the second end of the ring-shaped housing. In an embodiment, to facilitate mounting and manufacturing, the ring-shaped housing may be split into the first housing and the second housing, and to facilitate positioning and mounting of the first diaphragm, the first ring-shaped step may be disposed on an inner side or an outer side of the end surface of the first housing and the first ring-shaped mounting part, such as a steel ring, of the first diaphragm may be disposed at the first ring-shaped step, so that sealing effect between the first diaphragm and the first housing is good. Similarly, to facilitate positioning and mounting of the second diaphragm, the second ring-shaped step may be disposed on an inner side or an outer side of the end surface of the second housing and the second ring-shaped mounting part, such as a steel ring, of the second diaphragm may be disposed at the second ring-shaped step, so that sealing effect between the second diaphragm and the second housing is good. It may be understood that, when a working requirement and a processing condition are met, the first housing and the second housing may also be made as a whole.

In an embodiment, when the first voice coil and the second voice coil are connected to an alternating current, vibration directions of the first diaphragm and the second diaphragm are the same. In this way, sound wave superimposition can be implemented, to form high sound pressure, thereby improving low- and medium-frequency sensitivity.

In an embodiment, the first component is a first structure of an electronic device on which the dual-diaphragm speaker is mounted, and the second component is a sound output pipe of the electronic device. In other words, the dual-diaphragm speaker may cooperate with the first structure of the electronic device to form the first rear cavity and cooperate with the sound output pipe of the electronic device to form the second front cavity. In this way, a separate cover body does not need to be disposed in the dual-diaphragm speaker to form the first rear cavity and the second front cavity, which can reduce a volume and is conducive to achieving product miniaturization. In addition, because the sound output pipe and the dual-diaphragm speaker form the second front cavity, it is convenient to conduct a sound wave generated by the diaphragm to the sound output pipe.

In an embodiment, the dual-diaphragm speaker further includes: a first cover body, where the first cover body is in a sealed connection to the first diaphragm as the first component, to form the first rear cavity; and a second cover body, where the second cover body is in a sealed connection to the second diaphragm as the second component, to form the second front cavity, and the second front cavity is configured to communicate with a sound output pipe of an electronic device. The first rear cavity may be closed or communicate with the atmosphere. The first cover body and the second cover body are disposed in the dual-diaphragm speaker, the first cover body is in the sealed connection to the first diaphragm to form the first rear cavity, and the second cover body is in the sealed connection to the second diaphragm to form the second front cavity. In this way, the first rear cavity and the second front cavity do not need to be formed by using a structure of the electronic device, and the structure of the electronic device is slightly improved. Therefore, the dual-diaphragm speaker has a large application range, and can be used in more types of existing electronic devices.

In an embodiment, the first component is a first structure of an electronic device on which the dual-diaphragm speaker is mounted, and the dual-diaphragm speaker further includes: a second cover body, where the second cover body is in a sealed connection to the second diaphragm as the second component, to form the second front cavity, and the second front cavity is configured to communicate with a sound output pipe of the electronic device. The second cover body is disposed in the dual-diaphragm speaker, the second cover body is in the sealed connection to the second diaphragm to form the second front cavity, and the first structure of the electronic device and the first diaphragm may form the first rear cavity. In this way, the second front cavity does not need to be formed by using a structure of the electronic device, and the structure of the electronic device is slightly improved.

In an embodiment, the second component is used as a sound output pipe of an electronic device, and the dual-diaphragm speaker further includes: a first cover body, where the first cover body is, as the first component, in a sealed connection to the first diaphragm on the side surface that is of the first diaphragm and that is away from the magnetic circuit system, to form the first rear cavity. The first rear cavity may be closed or communicate with the atmosphere. The first cover body is disposed in the dual-diaphragm speaker, and the first cover body is in the sealed connection to the first diaphragm to form the first rear cavity. In this way, the first rear cavity does not need to be formed by using a structure of the electronic device, and the structure of the electronic device is slightly improved. In addition, because the sound output pipe of the electronic device and the second diaphragm of the dual-diaphragm speaker form the second front cavity, it is convenient to conduct sound waves generated by the two diaphragms to the sound output pipe.

According to a second aspect, an embodiment of this application provides an electronic device. The electronic device includes the dual-diaphragm speaker according to the first aspect; a first structure as the first component, connected to the first diaphragm on the side surface that is of the first diaphragm of the dual-diaphragm speaker and that is away from the magnetic circuit system, to form the first rear cavity; and a sound output pipe as the second component, connected to the second diaphragm on the side surface that is of the second diaphragm of the dual-diaphragm speaker and that is away from the magnetic circuit system, to form the second front cavity. The first rear cavity may be closed or communicate with the atmosphere.

According to a third aspect, an embodiment of this application provides an electronic device. The electronic device includes a sound output pipe and the dual-diaphragm speaker according to the first aspect. The dual-diaphragm speaker includes a first cover body and a second cover body, where the first cover body is in a sealed connection to the first diaphragm as the first component, to form the first rear cavity, and the second cover body is in a sealed connection to the second diaphragm as the second component, to form the second front cavity; and the second front cavity of the dual-diaphragm speaker communicates with the sound output pipe.

According to a fourth aspect, an embodiment of this application provides an electronic device. The electronic device includes the dual-diaphragm speaker according to the first aspect. The dual-diaphragm speaker includes a second covey body, where the second cover body is in a sealed connection to the second diaphragm as the second component, to form the second front cavity; a first structure as the first component, connected to the first diaphragm on the side surface that is of the first diaphragm of the dual-diaphragm speaker and that is away from the magnetic circuit system, to form the first rear cavity; and a sound output pipe, where the second front cavity of the dual-diaphragm speaker communicates with the sound output pipe. The first rear cavity may be closed or communicate with the atmosphere.

According to a fifth aspect, an embodiment of this application provides an electronic device. The electronic device includes the dual-diaphragm speaker according to the first aspect. The dual-diaphragm speaker includes a first cover body, where the first cover body is, as the first component, in a sealed connection to the first diaphragm on the side surface that is of the first diaphragm and that is away from the magnetic circuit system, to form the first rear cavity; and a sound output pipe as the second component, connected to the second diaphragm on the side surface that is of the second diaphragm of the dual-diaphragm speaker and that is away from the magnetic circuit system, to form the second front cavity.

Other features and advantages of the present disclosure are described in detail in the following part of embodiments.

### BRIEF DESCRIPTION OF DRAWINGS

The following briefly describes accompanying drawings used in describing embodiments or the conventional technology.

FIG. 1A is a schematic diagram of a structure of an electronic device according to an embodiment of this application;

FIG. 1B is a curve diagram of sound pressure levels obtained after sound waves of two diaphragms of the electronic device in FIG. 1A are superimposed;

FIG. 2 is a three-dimensional diagram of a dual-diaphragm speaker according to a first embodiment of this application;

FIG. 3 is a schematic diagram of an exploded structure of the dual-diaphragm speaker shown in FIG. 2;

FIG. 4 is a top view of the dual-diaphragm speaker shown in FIG. 2;

FIG. 5 is a schematic diagram of a sectional view structure along a V-V line in FIG. 4;

FIG. 6 is a schematic diagram of flow directions of currents in two voice coils of the magnetic circuit system shown in FIG. 5;

FIG. 7 is a three-dimensional top view of a first housing of the ring-shaped housing shown in FIG. 5;

FIG. 8 is a three-dimensional bottom view of the first housing of the ring-shaped housing shown in FIG. 5;

FIG. 9 is a three-dimensional top view of a second housing of the ring-shaped housing shown in FIG. 5;

FIG. 10 is three-dimensional bottom view of the second housing of the ring-shaped housing shown in FIG. 5;

FIG. 11 is a top view of another dual-diaphragm speaker according to the first embodiment of this application;

FIG. 12 is a schematic diagram of an exploded structure of the another dual-diaphragm speaker shown in FIG. 11;

FIG. 13 is a schematic diagram of a sectional view structure along an M-M line in FIG. 11;

FIG. 14 is a schematic diagram of a sectional view structure of a dual-diaphragm speaker according to a second embodiment of this application;

FIG. 15 is a schematic diagram of a sectional view structure of a dual-diaphragm speaker according to a third embodiment of this application;

FIG. 16 is a top view of the another dual-diaphragm speaker shown in FIG. 11 on which a cover body is disposed; and

FIG. 17 is a schematic diagram of a sectional view structure along an N-N line in FIG. 16.

### DESCRIPTION OF EMBODIMENTS

The following describes technical solutions in embodiments of this application with reference to accompanying drawings in embodiments of this application.

In descriptions of this application, locations or location relationships indicated by terms “center”, “up”, “down”, “in front of”, “behind”, “left”, “right”, “vertical”, “horizontal”, “top”, “bottom”, “inside”, “outside”, and the like are based on locations or location relationships shown in the accompanying drawings, and are merely intended for ease of describing this application and simplifying descriptions, instead of indicating or implying that a mentioned apparatus or component needs to be provided on a location or constructed and operated on a location, and therefore shall not be understood as limitations on this application.

In the descriptions of this application, it should be noted that, unless otherwise clearly specified and limited, terms “mount”, “link”, and “connect” should be understood in a broad sense, for example, may mean a fixed connection, may be a detachable connection, or may be a butt joint connection or an integrated connection. One of ordinary skilled in the art may interpret meanings of the foregoing terms in this application based on cases.

In the descriptions of this specification, the described features, structures, materials, or characteristics may be combined in a proper manner in any one or more of embodiments or examples.

An electronic device such as a semi-in-ear earphone is popular with most consumers because the semi-in-ear earphone does not have the stethoscope effect and is comfortable to wear. However, due to a semi-open architecture, the semi-in-ear earphone has a problem that leakage of a low- and medium-frequency sound wave (including a target signal and/or a noise canceling signal) is large. The target signal may be an audio signal, such as music or a voice, that needs to be played and that is sent by a speaker controlled by a processor or a controller in the earphone. The noise canceling signal is a signal that is in an inverted phase with noise, and the noise canceling signal and noise can cancel each other out, thereby achieving a noise canceling purpose. If the speaker is used for music playing and leaks a large quantity of low and medium frequencies of the target signal, for example, the music, sound quality is affected. If the speaker is used for noise canceling and leaks a large quantity of low and medium frequencies of the noise canceling signal, active noise canceling (ANC) effect of low- and medium-frequency noise is poor. The foregoing problems may be resolved by improving low- and medium-frequency sensitivity of the speaker. In other words, low- and medium-frequency sound waves generated by the speaker may be increased, to ensure that remaining low- and medium-frequency sound waves can still meet a usage requirement when the low- and medium-frequency sound waves have leakage, thereby ensuring the sound quality and/or the ANC effect.

An existing solution for improving the low-frequency sensitivity of the speaker has the following two ideas: One is to improve a force coefficient BL of the speaker, which usually requires increasing a magnetic energy density and increasing a quantity of coil turns. However, there are limitations on development of magnetic materials, stacking space of the earphone, and extension of high-frequency frequency bandwidth, and there is also a limitation on improvement of the force coefficient. The other is to increase an area of a diaphragm, which is usually achieved by increasing a speaker diameter for a single-diaphragm speaker. For example, for comfort, a diameter of the speaker of the earphone is usually designed to be less than 14 mm. Therefore, for a miniaturized device, space of a speaker that can be accommodated is limited, and an area of a diaphragm is also limited, which is not conducive to better improving low- and medium-frequency performance.

Another solution for increasing the area of the diaphragm is a dual-diaphragm speaker. However, in the conventional technology, the two diaphragms of the dual-diaphragm speaker have a problem of mutual influence, or cannot simultaneously have two advantages of a small volume and good low- and medium-frequency performance. In other words, areas of the two diaphragms cannot be simultaneously increased while ensuring the small volume. Therefore, for a miniaturized device, there is still a problem that low- and medium-frequency sensitivity performance of the speaker is poor.

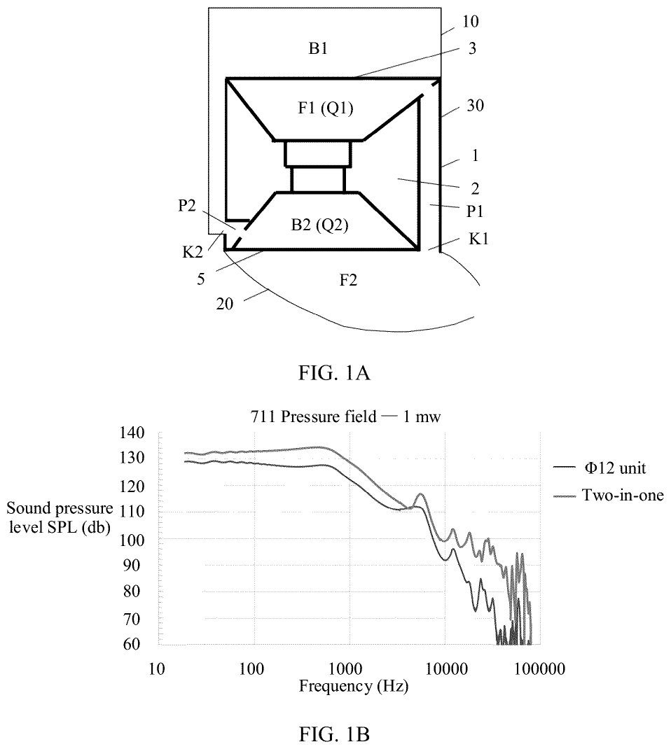

FIG. 1A is a schematic diagram of a structure of an electronic device according to an embodiment of this application. As shown in FIG. 1A, the electronic device includes a dual-diaphragm speaker 30, which usually includes a ring-shaped housing 1, a magnetic circuit system 2 disposed in the ring-shaped housing 1, a first diaphragm 3, a second diaphragm 5, and the like. The magnetic circuit system 2 divides space in the ring-shaped housing 1 into a first cavity Q1 and a second cavity Q2 in an axial direction. The magnetic circuit system 2 includes a first magnetic gap C1 and a second magnetic gap C2 (C1 and C2 are not shown in FIG. 1A, and for details, refer to FIG. 5, which is described below) disposed at a spacing around a principal axis. The second magnetic gap C2 is located on an inner side of the first magnetic gap C1. A first voice coil (not shown in FIG. 1A) connected to an inner surface of the first diaphragm 3 extends into the first magnetic gap C1, and a second voice coil (not shown in FIG. 1A) connected to an inner surface of the second diaphragm 5 extends into the second magnetic gap. A first front cavity may be formed on a side surface that is of the first diaphragm 3 and that faces the first cavity Q1, and a first rear cavity may be formed on a side surface that is of the first diaphragm 3 and that is away from the first cavity Q1. A second front cavity may be formed on a side surface that is of the second diaphragm 5 and that faces the second cavity Q2, and a second rear cavity may be formed on a side surface that is of the second diaphragm 5 and that is away from the second cavity Q2.

The front cavities and the rear cavities of the two diaphragms of the existing dual-diaphragm speaker are not respectively separated, and a high-frequency sound wave is not prone to a short circuit, while a low- and medium-frequency sound wave has a long wavelength and is prone to the short circuit, and the short circuit reduces low- and medium-frequency sound pressure and causes an acoustic performance loss. In addition, the existing dual-diaphragm speaker cannot simultaneously have two advantages of a small volume and good low- and medium-frequency performance (areas of both of the two diaphragms are large). Two types of dual-diaphragm speakers in the conventional technology are described below.

A dual-diaphragm speaker in Solution 1 of the conventional technology includes a treble unit and a bass unit, and sound on a side on which a voice coil is disposed on a diaphragm (corresponding to the second diaphragm 5 in FIG. 1A) of the bass unit is made through a hole of the second magnetic gap C2 and superimposed with the treble unit, with the aim of extending a frequency response of the speaker to a high frequency. Because the bass unit makes the sound through the hole of the second magnetic gap, a diameter of a diaphragm (corresponding to the first diaphragm 3 in FIG. 1A) of the treble unit cannot be greater than the hole of the second magnetic gap (if the diameter is greater than the hole, the hole is blocked). In this case, an area of the diaphragm of treble unit cannot be increased, and improvement of sensitivity is very limited.

In a dual-diaphragm speaker in Solution 2 of the conventional technology, two diaphragms reversely vibrate to make sound, and sound pressure of the two diaphragms is conducted to sound output openings by relying on a cavity structure of the entire speaker, with the aim of reducing the vibration and improving sound effect of the speaker on the premise that the speaker has a large amplitude. Because the diaphragm reversely vibrates and makes the sound, the cavity of the entire speaker needs to conduct and superimpose sound waves of the two diaphragms. Therefore, the entire speaker needs large space, which is not conducive to achieving miniaturization of the product and has a small application range.

In view of this, embodiments of this application provide a dual-diaphragm speaker and an electronic device including the dual-diaphragm speaker. The dual-diaphragm speaker separates sound wave transfer paths of front and rear cavities of the two diaphragms, so that a sound short circuit is avoided. Therefore, a low- and medium-frequency sound wave (including low and medium frequencies of a target signal such as music and/or low and medium frequencies of a noise canceling signal) is improved and high low- and medium-frequency sensitivity is implemented. In addition, in a case in which a small volume is achieved, an area of the diaphragm is large, more air is pushed, and sound pressure is high, which can further improve the low- and medium-frequency sensitivity. In other words, the dual-diaphragm speaker in embodiments of this application can simultaneously have two advantages of the small volume and the high low- and medium-frequency sensitivity, and may be used in a miniaturized or thin-sized scenario, for example, Hi-Fi audio playing or mid-bass enhancement, of electronic devices such as an earphone, a mobile phone, a notebook computer, a tablet computer, a speaker, and a television. In addition, it is convenient for the rear cavities of the two diaphragms of the dual-diaphragm speaker to communicate with the atmosphere, which can increase an amplitude of the diaphragm, generate the high sound pressure, and better improve the low- and medium-frequency sensitivity.

Still refer to FIG. 1A. The electronic device may include a first structure 10, a sound output pipe 20, and a dual-diaphragm speaker 30. The first structure 10 may be a battery or another structure of the electronic device, for example, a housing or a circuit board. The first diaphragm 3 of the dual-diaphragm speaker 30 and the magnetic circuit system 2 form a first front cavity F1, and the first structure 10 of the electronic device is connected to the first diaphragm 3 on a side surface that is of the first diaphragm 3 and that is away from the magnetic circuit system 2, to form a first rear cavity B1. The second diaphragm 5 of the dual-diaphragm speaker forms a second cavity B2 with the magnetic circuit system 2. The sound output pipe 20 of the electronic device is connected to the second diaphragm 5 on a side surface that is of the second diaphragm 5 and that is away from the magnetic circuit system 2, to form a second front cavity F2. The first front cavity F1 communicates with the second front cavity F2 through a first pipe P1 located in at least one of the magnetic circuit system 2 and the ring-shaped housing 1. The first pipe P1 is located on at least one of an outer peripheral wall of the magnetic circuit system 2 and an inner wall of the ring-shaped housing 1 or within a housing wall of the ring-shaped housing 1. In FIG. 1A, one end of the first channel P1 is connected to the first front cavity F1, and a port K1 of the other end of the first channel P1 is located on an end surface of a second end of the ring-shaped housing 1. The second rear cavity B2 may be closed or may communicate with the first rear cavity B1 or the atmosphere through at least one second channel P2. One end of the second channel P2 is connected to the second rear cavity B2, and a port K2 of the other end of the second channel P2 may be located at an outer rear wall of the ring-shaped housing 1 or at an end surface of a first end of the ring-shaped housing 1. The first rear cavity B1 may be closed or may communicate with the atmosphere.

According to the electronic device in embodiments of this application, the first front cavity F1 of the first diaphragm 3 is isolated from the first rear cavity B1, the second front cavity F2 of the second diaphragm 5 is isolated from the second rear cavity B2, and the second rear cavity B2 is not in communication with the first front cavity F1, so that the two diaphragms do not affect each other. The two diaphragms vibrate and make sound together, the first front cavity F1 can communicate with the second front cavity F2 through the first channel P1, and the first rear cavity B1 can communicate with the second rear cavity B2 through the second channel P2, thereby implementing sound pressure superimposition. This improves the low- and medium-frequency sensitivity of the speaker, can enhance the low- and medium-frequency sound wave of the noise canceling signal or the target signal, and provides better active noise canceling effect and/or sound quality experience for a consumer. In addition, the first channel P1 is close to the ring-shaped housing 1 and is located on an inner side and inside the ring-shaped housing, so that areas of the first diaphragm 3 and the second diaphragm 5 are large, and low- and medium-frequency performance is improved. In addition, a separate pipe does not need to be disposed outside the ring-shaped housing 1 to connect the two front cavities, thereby effectively reducing a volume of the speaker. This is conducive to achieving miniaturization of the electronic device and can further improve other performance such as wearing comfort and a battery life of the product.

FIG. 1B is a curve diagram of sound pressure levels obtained after sound waves of the two diaphragms of the electronic device in FIG. 1A are superimposed. As shown in FIG. 1B, “Φ12 unit” indicates a sound pressure level curve of a diaphragm with a diameter of 12 mm, that is, a curve located below, and “two-in-one” indicates a sound pressure level curve of the two diaphragms superimposed, that is, a curve located above. It can be learned from FIG. 1B that, after the two diaphragms are superimposed, both the low- and medium-frequency sound wave and a high-frequency sound wave are improved.

The following describes a structure of the dual-diaphragm speaker in the electronic device in embodiments of this application. The dual-diaphragm speaker in embodiments of this application has features such as high sensitivity, wide high-frequency bandwidth, and small occupied space. The two diaphragms vibrate in a same direction and make sound, the magnetic circuit system 2 and the ring-shaped housing 1 are used to form the channel, and the areas of the first diaphragm 3 and the second diaphragm 5 are large, so that the sound pressure is superimposed. In a case in which the small volume is ensured, the low- and medium-frequency sensitivity of the speaker is improved, so that ANC performance and/or sound quality experience of an electronic device, such as an earphone, to which a semi-open architecture of the speaker is applied are/is good.

It should be noted that, in the dual-diaphragm speaker in embodiments of this application, the second rear cavity B2 may be closed. In this case, there is no second channel P2, and only the first channel P1 exists. Alternatively, the second rear cavity B2 may communicate with the first rear cavity B1 or the atmosphere through at least one second channel P2. In this case, the first channel P1 and the second channel P2 may simultaneously exist, and the first channel P1 is not in communication with the second channel P2. The following uses an example in which the dual-diaphragm speaker has both the first channel P1 and the second channel P2 for description.

A first damping cloth for sealing may be disposed at the port K1 of the first channel P1. A second damping cloth for sealing may be disposed at the port K2 of the second channel P2. The damping cloth can prevent a foreign object from entering on the one hand, and on the other hand, the damping cloth can adjust acoustic performance such as a frequency response curve, a phase curve, and a distortion curve to an extent. In addition, there may be a plurality of options as for structures of the port K1 and the port K2, and the port may be an overall opening, or may be formed by a plurality of small openings. For example, a porous structure or a mesh structure is disposed at the port to form the plurality of small openings.

Further, more than two first channels P1 may be disposed in the dual-diaphragm speaker, and the more than two first channels P1 are disposed at a spacing in a circumferential direction of the ring-shaped housing 1. More than two second channels P2 may be disposed in the dual-diaphragm speaker, and the more than two second channels P2 are disposed at a spacing in the circumferential direction of the ring-shaped housing 1. In this way, the channel is evenly disposed, sound made is good, and force applied to the ring-shaped housing 1 is balanced.

In addition, the entire outer peripheral wall of the magnetic circuit system 2 may be in a sealed connection to the entire inner peripheral wall of the ring-shaped housing 1, and the first channel P1 may include a first through hole disposed in the magnetic circuit system 2 or the ring-shaped housing 1. In other words, the first through hole may be disposed inside the housing wall of the ring-shaped housing 1, or the first through hole may be disposed on the magnetic circuit system 2. One end of the first through hole is connected to the first front cavity F1, and the other end of the first through hole extends to the end surface of the second end of the ring-shaped housing 1. The second channel P2 may include a second through hole disposed on the magnetic circuit system 2 or the ring-shaped housing 1. The second through hole may be disposed inside the housing wall of the ring-shaped housing 1, or the second through hole may be disposed on the magnetic circuit system 2. One end of the second through hole is connected to the second rear cavity B2, and the other end extends to the end surface of the first end of the ring-shaped housing 1 or to an outer peripheral wall of the ring-shaped housing 1. In addition, to facilitate positioning and mounting of the magnetic circuit system 2 in the ring-shaped housing 1, and to prevent the magnetic circuit system 2 from moving in the axial direction of the ring-shaped housing 1, a first ring-shaped boss L1 is disposed on the inner wall of the first end of the ring-shaped housing 1, and the magnetic circuit system 2 is in a sealed connection to the first ring-shaped boss L1 on a side surface that is of the first ring-shaped boss L1 and that is away from the first diaphragm 3. A second ring-shaped boss L2 may be disposed on the inner wall of the second end of the ring-shaped housing 1, and the magnetic circuit system 2 is in a sealed connection to the second ring-shaped boss L2 on a side surface that is of the second ring-shaped boss L2 and that is away from the second diaphragm 5.

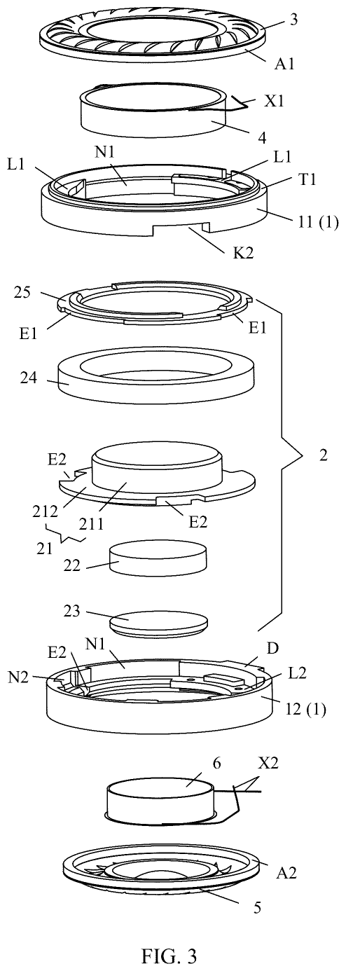

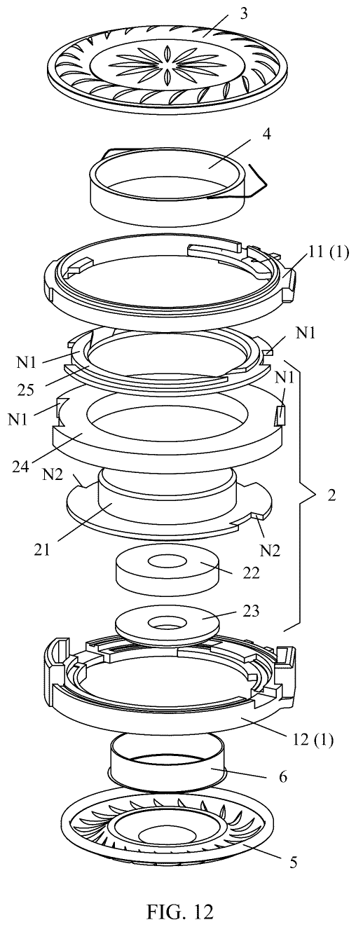

Alternatively, the first channel P1 may include a first opening groove N1 (refer to FIG. 3 or FIG. 12, which is described below) disposed on at least one of the inner wall of the ring-shaped housing 1 and the outer peripheral wall of the magnetic circuit system 2. The inner wall of the ring-shaped housing 1 and the outer peripheral wall of the magnetic circuit system 2 are in sealed contact to form the first channel P1 at the opening groove N1. In other words, the first opening groove N1 may be disposed only on the inner wall of the ring-shaped housing 1, and the first channel P1 may be formed between an outer peripheral wall that is of the magnetic circuit system 2 and that corresponds to the first opening groove N1 and the first opening groove N1. Alternatively, the first opening groove N1 may be disposed only on the magnetic circuit system 2, and the first channel P1 may be formed between an inner wall that is of the ring-shaped housing 1 and that corresponds to the first opening groove N1 and the first opening groove N1. Alternatively, the first opening groove N1 may be disposed on both the outer wall of the magnetic circuit system 2 and the inner wall of the ring-shaped housing 1, and the two first opening grooves N1 on the magnetic circuit system 2 and the ring-shaped housing 1 together form the first channel P1. Similarly, the second channel P2 may include a second opening groove N2 (refer to FIG. 3 or FIG. 12, which is described below) disposed on at least one of the inner wall of the ring-shaped housing 1 and the outer peripheral wall of the magnetic circuit system 2. The inner wall of the ring-shaped housing 1 and the outer wall of the magnetic circuit system 2 are in the sealed contact to form the second channel P2 at the second opening groove N2.

The following describes a structure of the dual-diaphragm speaker in embodiments of this application by using an example in which the opening groove is separately disposed on the ring-shaped housing 1 or the opening groove is separately disposed on the magnetic circuit system 2 to form the first channel P1 and the second channel P2.

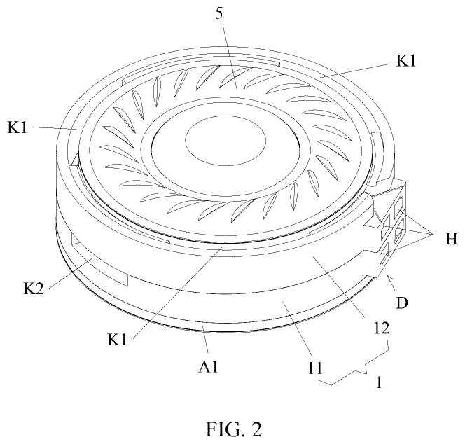

FIG. 2 is a three-dimensional diagram of a dual-diaphragm speaker according to a first embodiment of this application. FIG. 3 is a schematic diagram of an exploded structure of the dual-diaphragm speaker shown in FIG. 2. As shown in FIG. 2 and FIG. 3, the dual-diaphragm speaker includes a ring-shaped housing 1, a magnetic circuit system 2, a first diaphragm 3, a first voice coil 4, a second diaphragm 5, and a second voice coil 6. The magnetic circuit system 2 may include a first magnetic conductive member 21, a first magnet 22, a second magnetic conductive member 23, a second magnet 24, and a third magnetic conductive member 25.

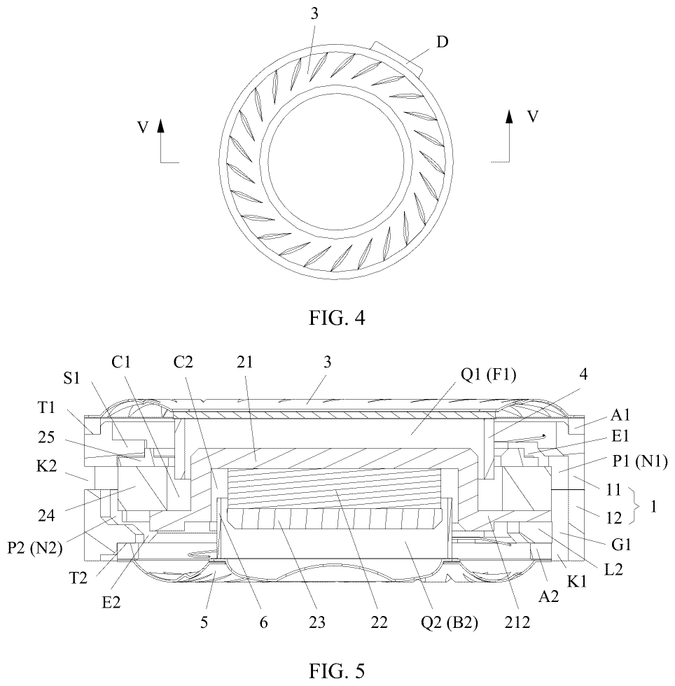

FIG. 4 is a top view of the dual-diaphragm speaker shown in FIG. 2. FIG. 5 is a schematic diagram of a sectional view structure along a V-V line in FIG. 4. As shown in FIG. 5, the magnetic circuit system 2 is disposed in the ring-shaped housing 1 and divides space in the ring-shaped housing 1 into a first cavity Q1 and a second cavity Q2 in a direction of a principal axis of the ring-shaped housing 1. The first diaphragm 3 is disposed at a first end of the ring-shaped housing 1, to form a first front cavity F1 with the first cavity Q1 and is configured to form a first rear cavity B1 with a first component such as the first structure 10 of the electronic device mentioned above on a side surface that is of the first diaphragm 3 and that is away from the magnetic circuit system 2. The first voice coil is disposed in the first front cavity F1. One end of the first voice coil 4 is connected to the first diaphragm 3, and the other end of the first voice coil 4 extends into a first magnetic gap C1. The second diaphragm 5 is disposed at a second end of the ring-shaped housing 1, to form a second rear cavity B2 with the second cavity Q2 and is configured to form a second front cavity F2 with a second component such as the sound output pipe 20 of the electronic device mentioned above on a side surface that is of the second diaphragm 5 and that is away from the magnetic circuit system 2. The second rear cavity B2 is not in communication with the first front cavity F1. The second voice coil 6 is disposed in the second rear cavity B2. One end of the second voice coil 6 is connected to the second diaphragm 5, and the other end of the second voice coil 6 extends into a second magnetic gap C2. The first voice coil 3 may be connected to the first diaphragm 3 in a bonding manner, and the second voice coil 6 may be connected to the second diaphragm 5 in the bonding manner. The first diaphragm 3 and the second diaphragm 5 can be mounted in the bonding manner.

A first ring-shaped boss L1 may be disposed at the first end of the ring-shaped housing 1, and a second ring-shaped boss L2 may be disposed at the second end of the ring-shaped housing 1. The following four solutions may be classified based on a case in which the ring-shaped boss is disposed on the ring-shaped housing 1.

Solution 1: The first ring-shaped boss L1 and the second ring-shaped boss L2 are not disposed on the ring-shaped housing 1.

As shown in FIG. 5, an outer peripheral wall of the magnetic circuit system 2 is in a sealed connection to an inner wall of the ring-shaped housing 1, an outer peripheral edge of the second diaphragm 5 is in a sealed connection to the magnetic circuit system 2, a first channel P1 includes a first opening groove N1 disposed on the inner wall of the ring-shaped housing 1 and/or on the outer peripheral wall of the magnetic circuit system 2, the first diaphragm 3 is in a sealed connection to an entire end surface of the first end of the ring-shaped housing 1, and first opening groove N1 extends from the first front cavity F1 to an end surface of the second end of the ring-shaped housing 1. Alternatively, the first diaphragm 3 is in a sealed connection to the magnetic circuit system 2, a first notch E1 communicating with the front cavity F1 is disposed on the magnetic circuit system 2, the first channel P1 further includes the first notch E1, and the first opening groove N1 extends from the first notch E1 to the end surface of the second end of the ring-shaped housing 1.

Further, the second rear cavity B2 may communicate with the first rear cavity B1 or the atmosphere through a second channel P2, and a second notch E2 communicating with the second rear cavity B2 is disposed on the magnetic circuit system 2; and the second channel P2 includes a port K2, the second notch E2, and a second opening groove N2 disposed on the inner wall of the ring-shaped housing 1 and/or on the outer peripheral wall of the magnetic circuit system 2, the port K2 is disposed on an outer peripheral wall of the ring-shaped housing 1, and the second opening groove N2 extends from the second notch E2 to the port K2.

Solution 2: The first ring-shaped boss L1 is disposed on the ring-shaped housing 1, but the second ring-shaped boss L2 is not disposed.

As shown in FIG. 5, the first ring-shaped boss L1 is disposed on an inner wall of the first end of the ring-shaped housing 1, the first diaphragm 3 is in a sealed connection to the first ring-shaped boss L1, the magnetic circuit system 2 is connected to a side surface that is of the first ring-shaped boss L1 and that is away from the first diaphragm 3, an outer peripheral wall of the magnetic circuit system 2 is in a sealed connection to an inner wall of the ring-shaped housing 1, an outer peripheral edge of the second diaphragm 5 is in a sealed connection to the magnetic circuit system 2, a first notch E1 communicating with the first front cavity F1 is disposed on at least one of the first ring-shaped boss L1 and the magnetic circuit system 2, the first channel P1 includes the first notch E1 and a first opening groove N1 disposed on the inner wall of the ring-shaped housing 1 and/or on the outer peripheral wall of the magnetic circuit system 2, and the first opening groove N1 extends from the first notch E1 to an end surface of the second end of the ring-shaped housing 1.

Further, the second rear cavity B2 may communicate with the first rear cavity B1 or the atmosphere through the second channel P2, and a second notch E2 communicating with the second rear cavity B2 is disposed on the magnetic circuit system 2; and the second channel P2 includes a port K2, the second notch E2, and a second opening groove N2 disposed on the inner wall of the ring-shaped housing 1 and/or on the outer peripheral wall of the magnetic circuit system 2, the port K2 is disposed on an outer peripheral wall of the ring-shaped housing 1, and the second opening groove N2 extends from the second notch E2 to the port K2.

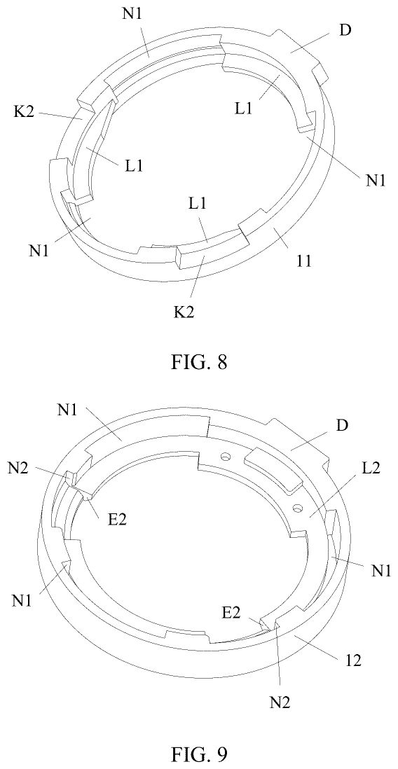

The first ring-shaped boss L1 includes at least one first arc-shaped section, and the first arc-shaped section is disposed on a part that is of an inner wall of the first end of the ring-shaped housing 1 and at which the first opening groove N1 is not disposed. In other words, to facilitate communication between the first opening groove N1 and the first front cavity F1, the first ring-shaped boss L1 may not be disposed at the first opening groove N1, and the first ring-shaped boss L1 is not disposed around an entire inner peripheral wall of the ring-shaped housing 1. When only one first opening groove N1 is disposed on the ring-shaped housing 1, the first ring-shaped boss L1 may include a first arc-shaped section, and two ends of the first arc-shaped section are disposed at a spacing at the first opening groove N1, so that the first opening groove N1 communicates with the first front cavity F1. When two first opening grooves N1 are disposed on the ring-shaped housing 1, the first ring-shaped boss L1 may include two first arc-shaped sections, and the two first arc-shaped sections are disposed at a spacing at the first opening grooves N1, so that the first opening grooves N1 communicate with the first front cavity F1. When three first opening grooves N1 are disposed on the ring-shaped housing 1, the first ring-shaped boss L1 may include three first arc-shaped sections, and two adjacent first arc-shaped sections of the three first arc-shaped sections are disposed at a spacing at the first opening grooves N1, so that the first opening grooves N1 communicate with the first front cavity F1. As shown in FIGS. 7 and 8 which are described below, the first ring-shaped boss L1 includes three first arc-shaped sections in a circumferential direction of the ring-shaped housing 1.

Solution 3: The first ring-shaped boss L1 is not disposed on the ring-shaped housing 1, but the second ring-shaped boss L2 is disposed.

As shown in FIG. 5, the second ring-shaped boss L2 is disposed on an inner wall of the second end of the ring-shaped housing 1, the second diaphragm 5 is in a sealed connection to the second ring-shaped boss L2, the magnetic circuit system 2 is connected to a side surface that is of the second ring-shaped boss L2 and that is away from the second diaphragm 5, and the first channel P1 includes a first opening groove N1 disposed on an inner wall of the ring-shaped housing 1 and/or on an outer peripheral wall of the magnetic circuit system 2; and the first diaphragm 3 is in a sealed connection to an entire end surface of the first end of the ring-shaped housing 1, and the first opening groove N1 extends from the first front cavity F1 to an end surface of the second end of the ring-shaped housing 1 and penetrates the second ring-shaped boss L2; or the first diaphragm 3 is in a sealed connection to the magnetic circuit system 2, a first notch E1 communicating with the front cavity F1 is disposed on the magnetic circuit system 2, the first channel P1 further includes the first notch E1, and the first opening groove N1 extends from the first notch E1 to the end surface of the second end of the ring-shaped housing 1.

Further, the second rear cavity B2 communicates with the first rear cavity B1 or the atmosphere through the second channel P2, and a second notch E2 communicating with the second rear cavity B2 is disposed on at least one of the second ring-shaped boss L2 and the magnetic circuit system 2; and the second channel P2 includes a port K2, the second notch E2, and a second opening groove N2 disposed on the inner wall of the ring-shaped housing 1 and/or on the outer peripheral wall of the magnetic circuit system 2, the port K2 is disposed on an outer peripheral wall of the ring-shaped housing 1, and the second opening groove N2 extends from the second notch E2 to the port K2.

Solution 4: The first ring-shaped boss L1 and the second ring-shaped boss L2 are disposed on the ring-shaped housing 1.

As shown in FIG. 5, the first ring-shaped boss L1 is disposed on an inner wall of the first end of the ring-shaped housing 1, the second ring-shaped boss L2 is disposed on an inner wall of the second end of the ring-shaped housing 1, the magnetic circuit system 2 is connected between the first ring-shaped boss L1 and the second ring-shaped boss L2, an outer peripheral wall of the magnetic circuit system 2 is in a sealed connection to an inner wall of the ring-shaped housing 1, an outer peripheral edge of the first diaphragm 3 is in a sealed connection to the first ring-shaped boss L1, and an outer peripheral edge of the second diaphragm 5 is in a sealed connection to the second ring-shaped boss L2; and a first notch E1 communicating with the first front cavity F1 is disposed on at least one of the first ring-shaped boss L1 and the magnetic circuit system 2, the first channel P1 includes the first notch E1 and a first opening groove N1 disposed on the inner wall of the ring-shaped housing 1 and/or on the outer peripheral wall of the magnetic circuit system 2, and the first opening groove N1 extends from the first notch E1 to an end surface of the second end of the ring-shaped housing 1 and penetrates the second ring-shaped boss L2.

Further, the second rear cavity B2 communicates with the first rear cavity B1 or the atmosphere through the second channel P2, and a second notch E2 communicating with the second rear cavity B2 is disposed on at least one of the second ring-shaped boss L2 and the magnetic circuit system 2; and the second channel P2 includes a port K2, the second notch E2, and a second opening groove N2 disposed on the inner wall of the ring-shaped housing 1 and/or on the outer peripheral wall of the magnetic circuit system 2, the port K2 is disposed on an outer peripheral wall of the ring-shaped housing 1, and the second opening groove N2 extends from the second notch E2 to the port K2.

In addition, in the foregoing four solutions, as shown in FIG. 3 and FIG. 5, the first magnetic conductive member 21 includes a concave part 211 and a ring-shaped flange 212 disposed around an opening of the concave part 211, the concave part 211 includes a bottom wall and a side wall disposed around the bottom wall, and the opening of the concave part 211 faces the second diaphragm 5 or the first diaphragm 3. The first magnet 22 and the second magnetic conductive member 23 are stacked in the concave part 211, and the first magnet 22 is located between the bottom wall of the concave part 211 and the second magnetic conductive member 23, and the magnetic circuit system 2 includes the first magnetic gap C1 and the second magnetic gap C2 that are disposed at a spacing around the principal axis. Specifically, the first magnet 22 and the second magnetic conductive member 23 are disposed at a spacing from the side wall of the concave part 211 to form the second magnetic gap C2. The second magnet 24 and the third magnetic conductive member 25 are stacked on the ring-shaped flange 212 around the concave part 211, and the second magnet 24 is located between the ring-shaped flange 212 and the third magnetic conductive member 25. The second magnet 24 and the third magnetic conductive member 25 are disposed at a spacing from the side wall of the concave part 211 to form the first magnetic gap C1. At least one of the ring-shaped flange 212, the second magnet 24, and the third magnetic conductive member 25 are connected to the ring-shaped housing 1.

All components of the magnetic circuit system 2 may have a same principal axis. The first magnet 22 is bonded to the second magnetic conductive member 23 on a surface that is of the first magnet 22 and that is away from the first magnetic conductive member 21. The second magnet 24 is bonded to the third magnetic conductive member 25 on a surface that is of the second magnet 24 and that is away from the first magnetic conductive member 21. The magnetic circuit system 2 formed by the first magnetic conductive member 21, the first magnet 22, the second magnetic conductive member 23, the second magnet 24, and the third magnetic conductive member 25 divides the inner space of the ring-shaped housing 1 into the first cavity Q1 and the second cavity Q2, and the first cavity Q1 is not in communication with the second cavity Q2. The first voice coil 4 and the second voice coil 6 are coaxially place in the magnetic gap. One end of the first voice coil 4 is suspended, and the other end of the first voice coil 4 is bonded to the first diaphragm 3. One end of the second voice coil 6 is suspended, and the other end of the second voice coil 6 is bonded to the second diaphragm 5. The outer peripheral edge of the first diaphragm 3 is fastened to the ring-shaped housing 1, and the outer peripheral edge of the second diaphragm 5 is fastened to the ring-shaped housing 1. A sound wave that is of the first diaphragm 3 and that is close to the voice coil surface (in the first front cavity F1) is conducted through the first pipe P1, and a sound wave that is of the second diaphragm 5 and that is close to the voice coil surface (in the second rear cavity B2) is conducted through the second pipe P2. The first diaphragm 3 and the second diaphragm 5 simultaneously make sound, and sound waves are superimposed through conduction of the pipes, so that frequency bandwidth expansion and mid-bass enhancement can be implemented. Compared with a single-diaphragm speaker, a purpose of simultaneously improving treble and bass can be achieved.

Magnetic lines of the two magnets from closed loops through magnetic force convergence of the three magnetic conductive members, and the two voice coils are coaxially placed in the middle of the magnetic gap. The magnetic circuit system 2 enables the first diaphragm 3 and the second diaphragm 5 to share a magnetic circuit. In this way, two magnetic circuit systems do not need to be disposed, which can improve utilization of magnetic energy and save space, reduce a volume of the speaker, and facilitate miniaturization of the electronic device, so that an electronic device using the speaker, such as an earphone, is more comfortable to wear or more space can be used for mounting a battery, which helps improve a battery life of the electronic device.

To implement the sound wave superimposition, when the first voice coil 4 and the second voice coil 6 of the magnetic circuit system are connected to an alternating current, vibration directions of the first diaphragm 3 and the second diaphragm 5 are the same. Specifically, there may be but is not limited to the following two cases:

Case 1: Magnetism of the first magnet 22 in the direction of the principal axis is opposite to magnetism of the second magnet 24 in the direction of the principal axis, the second magnet 24 and the first magnet 22 that are magnetized in an axial direction and that are in opposite magnetization directions are coaxially connected by using the first magnetic conductive member 21 shared by the second magnet 24 and the first magnet 22, and the three magnetic conductive members play a role of magnetic force convergence, so that the magnetic lines of the first magnet 22 and the second magnet 24 form the two closed loops respectively around the first magnetic gap C1 and the second magnetic gap C2 through the magnetic force convergence of the three magnetic conductive members. Specifically, the second magnet 24 and the first magnet 22 are magnetized in the axial direction, and the magnetization directions are opposite. For example, the magnetism of the first magnet 22 in a direction from the second diaphragm 5 to the first diaphragm 3 is that an S pole points to an N pole, the magnetism of the second magnet 24 in the direction from the second diaphragm 5 to the first diaphragm 3 is that the N pole points to the S pole, and the magnetic line forms the magnetic line closed loop from the second magnet 24>the first magnetic conductive member 21>the second magnetic conductive member 23>the first magnet 22>the first magnetic conductive member 21>the third magnetic conductive member 25>the second magnet 24.

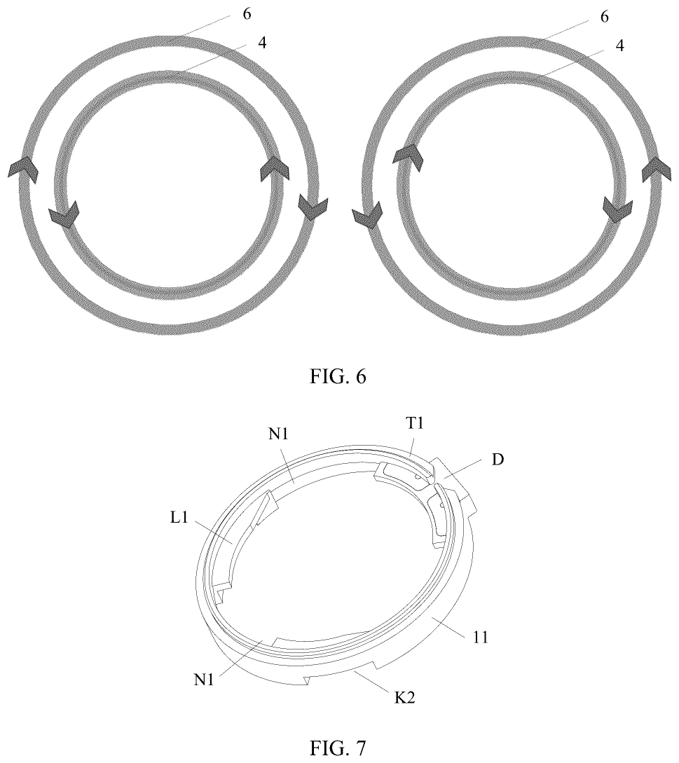

FIG. 6 is a schematic diagram of flow directions of currents in the two voice coils of the magnetic circuit system of the dual-diaphragm speaker shown in FIG. 5. As shown in FIG. 6, the magnetism of the first magnet 22 in the direction of the principal axis is opposite to the magnetism of the second magnet 24 in the direction of the principal axis, and current directions in the first voice coil 4 and the second voice coil 6 are opposite, so that the vibration directions of the first diaphragm 3 and the second diaphragm 5 are the same. In other words, with reference to the magnetization direction of the magnet, winding of the voice coil, and wiring of the positive and negative poles of the speaker unit, it is ensured that the current directions in the two voice coils are opposite at a same moment, so that the two diaphragms simultaneously vibrate in a same direction, the sound wave superimposition is implemented, and an output sound pressure level is the highest.

Case 2: Magnetism of the first magnet 22 in the direction of the principal axis is the same as magnetism of the second magnet 24 in the direction of the principal axis, and current directions in the first voice coil 4 and the second voice coil 6 are the same, so that the vibration directions of the first diaphragm 3 and the second diaphragm 5 are the same.

In addition, it should be noted that the magnetic circuit system 2 of the dual-diaphragm speaker in an embodiment of the application may have a plurality of structures, provided that when disposed in the ring-shaped housing 1, the magnetic circuit system 2 can divide, in the axial direction, the pace in the ring-shaped housing 1 into the first cavity Q1 and the second cavity Q2 that are not in communication, and the first magnetic gap C1 and the second magnetic gap C2 exist.

FIG. 7 is a three-dimensional top view of a first housing of the ring-shaped housing shown in FIG. 5. FIG. 8 is a three-dimensional bottom view of the first housing of the ring-shaped housing shown in FIG. 5. As shown in FIG. 5, the ring-shaped housing 1 may include a first housing 11 and a second housing 12 that are arranged in the direction of the principal axis. The first end of the ring-shaped housing 1 is an end that is of the first housing 11 and that is away from the second housing 12, and the second end of the ring-shaped housing 1 is an end that is of the second housing 12 and that is away from the first housing 11. As shown in FIG. 5, FIG. 7, and FIG. 8, a first ring-shaped step T1 is disposed on an outer side or an inner side of the end that is of the first housing 11 and that is away from the second housing 12, a first ring-shaped mounting part A1 is disposed on the outer peripheral edge of the first diaphragm 3, and the first ring-shaped mounting part A1 is disposed at the first ring-shaped step T1, to implement a sealed connection between the outer peripheral edge of the first diaphragm 3 and the end surface of the first end of the ring-shaped housing 1. In addition, as shown in FIG. 7 and FIG. 8, a part of the first opening groove N1, the first ring-shaped boss L1, the port K2, and a part of a positioning boss D described below may be disposed on the first housing 11.

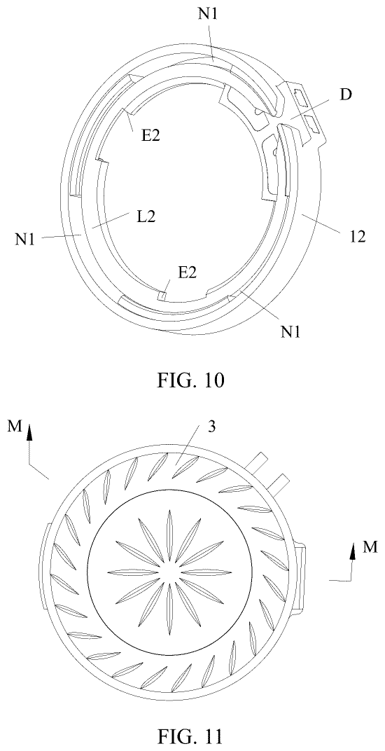

FIG. 9 is a three-dimensional top view of a second housing of the ring-shaped housing shown in FIG. 5. FIG. 10 is three-dimensional bottom view of the second housing of the ring-shaped housing shown in FIG. 5. As shown in FIG. 5, FIG. 9, and FIG. 10, a second ring-shaped step T2 is disposed on an outer side or an inner side of the end that is of the second housing 12 and that is away from the first housing 11, a second ring-shaped mounting part A2 is disposed on the outer peripheral edge of the second diaphragm 5, and the second ring-shaped mounting part A2 is disposed at the second ring-shaped step, to implement a sealed connection between the outer peripheral edge of the second diaphragm 5 and the end surface of the second end of the ring-shaped housing 1. In addition, as shown in FIG. 9 and FIG. 10, another part of the first opening groove N1, the second opening groove N2, the second ring-shaped boss L2, and another part of the positioning boss D described below may be disposed on the first housing 11.

In other words, to facilitate mounting and manufacturing, the ring-shaped housing 1 may be split into the first housing 11 and the second housing 12, and to facilitate positioning and mounting of the first diaphragm 3, the first ring-shaped step T1 may be disposed on the end surface of the first housing 11 and the first ring-shaped mounting part A1, such as a steel ring, of the first diaphragm 3 may be disposed at the first ring-shaped step T1, so that sealing effect between the first diaphragm 3 and the first housing 11 is good. Similarly, to facilitate positioning and mounting of the second diaphragm 5, the second ring-shaped step T2 may be disposed on the end surface of the second housing 12 and the second ring-shaped mounting part A2, such as a steel ring, of the second diaphragm 5 may be disposed at the second ring-shaped step T2, so that sealing effect between the second diaphragm 5 and the second housing 12 is good. It may be understood that, when a working requirement and a processing condition are met, the first housing 11 and the second housing 12 may also be made as a whole.

As shown in FIG. 7 to FIG. 10, the positioning boss D is disposed on the outer peripheral wall of the ring-shaped housing 1, and a plurality of through holes communicating with an inner side and an outer side of the ring-shaped housing 1 are disposed on the positioning boss D. As shown in FIG. 3, a first voice coil line X1 is disposed on the first voice coil 4, a second voice coil line X2 is disposed on the second voice coil 6, the first voice coil line X1 and the second voice coil line X2 are respectively electrically connected to a power amplifier apparatus through the plurality of through holes, and the positioning boss D and at least one port K1 may be disposed at a spacing in the circumferential direction of the ring-shaped housing 1. The positioning boss D and at least one port K2 may be disposed at a spacing in the circumferential direction of the ring-shaped housing 1. The positioning boss D is disposed, to facilitate positioning and mounting of the dual-diaphragm speaker to the electronic device, and ensure that the port K1 and the port K2 correspond to corresponding positions of the electronic device. The voice coil may include a ring-shaped support bracket and a plurality of turns of voice coil lines disposed around the ring-shaped support bracket. Alternatively, the voice coil may include a ring-shaped metal bracket and the voice coil line connected to the ring-shaped metal bracket. The voice coil and the power amplifier apparatus may be electrically connected in but not limited to the following two manners:

Manner 1: During injection molding of the ring-shaped housing 1, a metal soldering pad H (as shown in FIG. 2) is embedded in a part at which the positioning boss D is formed on the ring-shaped housing 1, and a part of the metal soldering pad H is located in the ring-shaped housing 1, and the other part of the metal soldering pad H is exposed from the ring-shaped housing 1. The first voice coil line X1 and the second voice coil line X2 are connected to the metal soldering pad H inside the ring-shaped housing 1, and the metal soldering pad H is connected to the external power amplifier apparatus. In this way, the voice coil line is not exposed from the ring-shaped housing 1, and the voice coil line can be well protected, to prevent the voice coil line from being damaged. In other words, the positioning boss D is disposed on the outer peripheral wall of the ring-shaped housing 1, which not only plays a role of positioning and assembly, but also facilitates the connection of the voice coil line and the external circuit.

Manner 2: The voice coil line may be extended through the through hole at the positioning boss D and connected to the power amplifier apparatus, which reduces difficulty in processing the ring-shaped housing 1 and helps improve a processing speed and reduce costs.

In addition, in FIG. 5, the first opening groove N1 and the second opening groove N2 are disposed on the inner wall of the ring-shaped housing 1, and the first opening groove N1 and the second opening groove N2 may also be disposed on the magnetic circuit system. For details, refer to FIG. 11 to FIG. 13, which are described below.

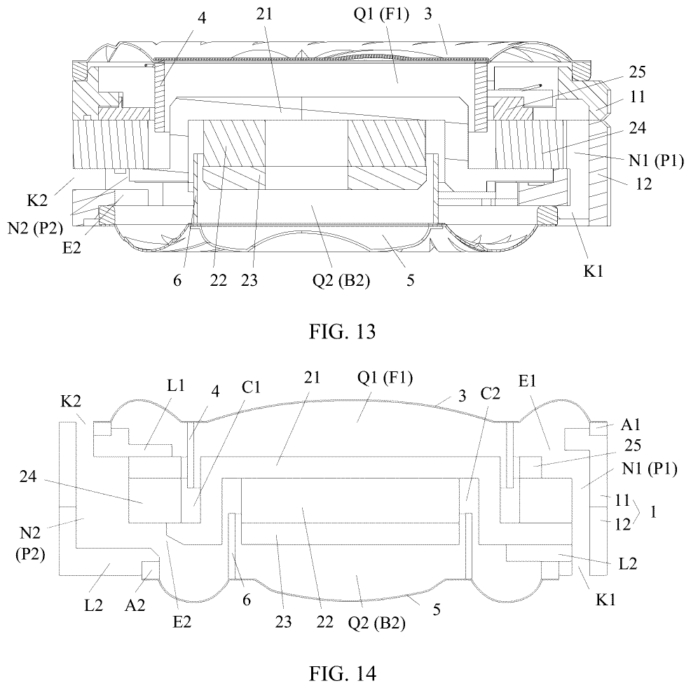

FIG. 11 is a top view of another dual-diaphragm speaker according to the first embodiment of this application. FIG. 12 is a schematic diagram of an exploded structure of the dual-diaphragm speaker shown in FIG. 11. FIG. 13 is a schematic diagram of a sectional view structure along an M-M line in FIG. 11. As shown in FIG. 11 to FIG. 13, the first opening groove N1 and the second opening groove N2 are disposed on the magnetic circuit system 2. As shown in FIG. 12, the first opening groove N1 may be disposed on the second magnet 24 and the third magnetic conductive member 25 of the magnetic circuit system 2. The second opening groove N2 is located on the first magnetic conductive member 21, that is, a length of the first opening groove N2 is short and may be disposed only on the first magnetic conductive member 21, but may also be disposed on the second magnet 24 when a requirement is provided.

FIG. 14 is a schematic diagram of a sectional view structure of a dual-diaphragm speaker according to a second embodiment of this application. As shown in FIG. 14, for a structure of the first channel P1 in the four cases in which the first ring-shaped boss L1 and the second ring-shaped boss L2 are not disposed on the ring-shaped housing 1, only the first ring-shaped boss L1 is disposed, only the second ring-shaped boss L2 is disposed, and the first ring-shaped boss L1 and the second ring-shaped boss L2 are disposed, refer to the foregoing description of FIG. 5. The following describes only another structure of the second channel P2 in the four cases with reference to FIG. 14.

When the first ring-shaped boss L1 and the second ring-shaped boss L2 are not disposed on the ring-shaped housing 1, the first diaphragm 3 is in a sealed connection to the magnetic circuit system 2, the second channel P2 may include a second notch E2 and a second opening groove N2 disposed on the inner wall of the ring-shaped housing 1 and/or on the outer peripheral wall of the magnetic circuit system 2, and the second opening groove N2 extends from the second notch E2 to the end surface of the first end of the ring-shaped housing 1.

When only the first ring-shaped boss L1 is disposed on the ring-shaped housing 1, but the second ring-shaped boss L2 is not disposed, the second channel P2 includes a second notch E2 and a second opening groove N2 disposed on the inner wall of the ring-shaped housing 1 and/or on the outer peripheral wall of the magnetic circuit system 2, and the second opening groove N2 extends from the second notch E2 to the end surface of the first end of the ring-shaped housing 1 and penetrates the first ring-shaped boss L1.

When only the second ring-shaped boss L2 is disposed on the ring-shaped housing 1, but the first ring-shaped boss L1 is not disposed, the first diaphragm 3 is in a sealed connection to the magnetic circuit system 2, the second channel P2 may include a second opening groove N2 disposed on the inner wall of the ring-shaped housing 1 and/or on the outer peripheral wall of the magnetic circuit system 2 and a second notch E2, and the second opening groove N2 extends from the second notch E2 to the end surface of the first end of the ring-shaped housing 1.

When the first ring-shaped boss L1 and the second ring-shaped boss L2 are disposed on the ring-shaped housing 1, the second channel P2 includes a second notch E2 and a second opening groove N2 disposed on the inner wall of the ring-shaped housing 1 and/or on the outer peripheral wall of the magnetic circuit system 2, and the second opening groove N2 extends from the second notch E2 to the end surface of the first end of the ring-shaped housing 1 and penetrates the second ring-shaped boss L2.

It should be noted that, for a case in which the second rear cavity B2 is closed (that is, there is no second channel P2), refer to the design manner of the first channel P1 in the foregoing embodiment described in FIG. 5 to FIG. 14.

A high-frequency sound wave is not prone to a short circuit and a low- and medium-frequency sound wave has a long wavelength and is prone to the short circuit, and the short circuit reduces low- and medium-frequency sound pressure and causes an acoustic performance loss. Therefore, in an embodiment of the application, sound wave transfer paths of the front cavities and the rear cavities of the two diaphragms are respectively separated, so that a sound short circuit can be avoided. When the sound wave superimposition is performed, the low- and medium-frequency sound wave (including low and medium frequencies of a target signal and/or low and medium frequencies of a noise canceling signal) can be improved, the low- and medium-frequency sensitivity of the speaker is improved, good low- and medium-frequency noise canceling effect is achieved, and/or the low and medium frequencies of the target signal is enhanced. In addition, communication between the first front cavity and the second front cavity is implemented through the first channel located on the inner side or inside the ring-shaped housing, which facilitates the connection to the sound output pipe of the electronic device. Compared with a solution in which a pipe is disposed outside the ring-shaped housing to connect the first front cavity and the second front cavity, this reduces the volume and is conducive to achieving the miniaturization. In addition, because the diaphragm can be disposed on the end surface of the ring-shaped housing, the area of the diaphragm is large, more air is pushed, and the sound pressure is high, which can further improve the low- and medium-frequency sensitivity of the speaker.

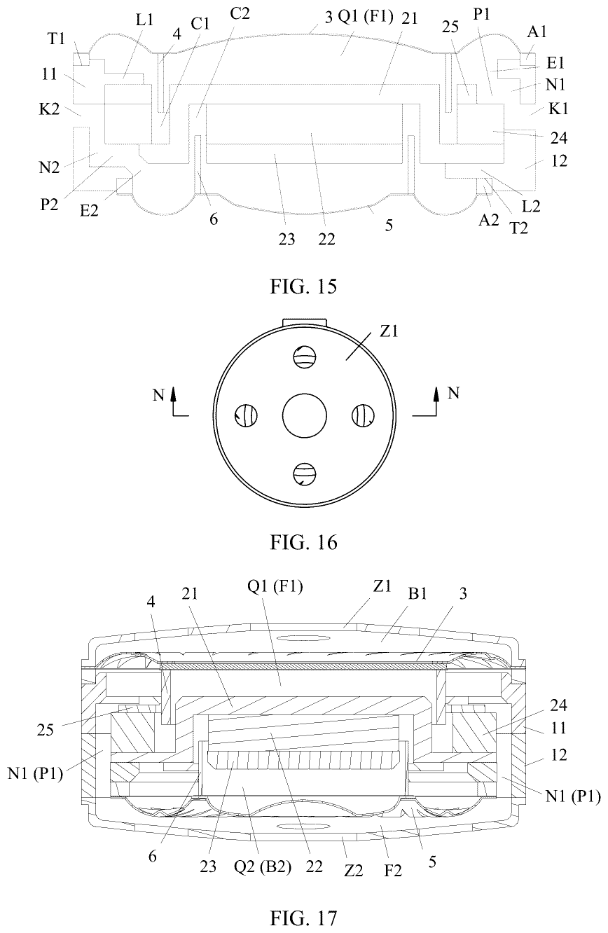

FIG. 15 is a schematic diagram of a sectional view structure of a dual-diaphragm speaker according to a third embodiment of this application. As shown in FIG. 15, the port K1 is located on the outer peripheral wall of the ring-shaped housing 1, and the port K2 is located on the outer peripheral wall of the ring-shaped housing 1. At least one first opening groove N1 is disposed on the inner wall of the ring-shaped housing 1, and the first opening groove N1 extends from the first front cavity F1 to the port K1 and communicates with the port K1. The first diaphragm 3 seals and covers the entire end surface of the first end of the ring-shaped housing 1. At least one second opening groove N2 is disposed on the inner wall of the ring-shaped housing 1, and the second opening groove N2 extends from the second rear cavity B2 to the port K2 and communicates with the port K2. The second diaphragm 5 seals and covers the entire end surface of the second end of the ring-shaped housing 1. A part of the outer peripheral wall of the magnetic circuit system 2 is in a sealed connection to the inner wall of the ring-shaped housing 1, and an outer peripheral wall that is of the magnetic circuit system 2 and that corresponds to the first opening groove N1 forms the first channel P1 with the first opening groove N1. An outer peripheral wall that is of the magnetic circuit system 2 and that corresponds to the second opening groove N2 forms the second channel P2 with the second opening groove N2. The first opening groove N1 may be disposed only on the outer peripheral wall of the magnetic circuit system 2. The second opening groove N2 and the first opening groove N1 cooperate with the inner wall of the ring-shaped housing 1 to form the first channel P1, and the second opening groove N2 cooperates with the inner wall of the ring-shaped housing 1 to form the second channel P2. Alternatively, opening grooves may be simultaneously disposed on the outer peripheral wall of the magnetic circuit system 2 and the inner wall of the ring-shaped housing 1 to form the first channel P1 and the second channel P2.

In addition, the port K1 may be disposed on the first housing 11 and/or on the second housing 12. In other words, the port K1 may be disposed only on the first housing 11, or may be disposed only on the second housing 12, or a part of the port K1 may be disposed on the first housing 11, and the other part of the port K1 may be disposed on the second housing 12. The port K2 may be disposed on the first housing 11 and/or on the second housing. In other words, the port K2 may be disposed only on the first housing 11, or may be disposed only on the second housing 12, or a part of the port K2 may be disposed on the first housing 11, and the other part of the port K2 may be disposed on the second housing 12.

In addition, positions of two or more ports K1 in the direction of the principal axis may be the same or different. Positions of two or more ports K2 in the direction of the principal axis may be the same or different. The following uses the port K2 as an example for description. Specifically, one of the more than two ports K2 may be located on an end surface that is of the first housing 11 and that is in contact with the second housing 12. For example, an opening groove is disposed on the end surface of the first housing 11, and the opening groove cooperates with an end surface of the second housing 12 to form the port K2. The other of the more than two ports K2 may be located on an end surface that is of the second housing 12 and that is in contact with the first housing 11. An opening groove is disposed on the end surface of the second housing 12, and the opening groove cooperates with an end surface of the first housing 11 to form the port K2.

In an example, to facilitate mounting of the magnetic circuit system 2, and to prevent the magnetic circuit system 2 from moving in the direction of the principal axis of the ring-shaped housing 1, a boss may be disposed on the inner wall of the ring-shaped housing 1. Specifically, the first ring-shaped boss L1 is disposed on the part that is of the inner wall of the first end of the ring-shaped housing 1 and at which the first opening groove N1 is not disposed, the second ring-shaped boss L2 is disposed on a part that is of the inner wall of the second end of the ring-shaped housing 1 and at which the second opening groove N2 is not disposed, and the magnetic circuit system 2 is located between the first ring-shaped boss L1 and the second ring-shaped boss L2 and is fastened to the first ring-shaped boss L1 and the second ring-shaped boss L2.

In the dual-diaphragm speaker according to the third embodiment of this application, both the port K1 and the port K2 are located on the outer peripheral wall of the ring-shaped housing 1. In this way, no space for disposing the port needs to be reserved on a mounting surface of the diaphragm, that is, the end surface of the ring-shaped housing. The first diaphragm 3 can seal and cover an entire opening of the first end of the ring-shaped housing 1, and the second diaphragm 5 can seal and cover an entire opening of the second end of the ring-shaped housing 1, so that areas of the first diaphragm 3 and the second diaphragm 5 are large and more air can be pushed. This generates more low- and medium-frequency sound waves and helps improve noise canceling effect.

In the foregoing embodiment, the dual-diaphragm speaker needs to cooperate with the structure of the electronic device to form the first rear cavity B1 and the second front cavity F2. In addition, a first cover body Z1 may be disposed on the dual-diaphragm speaker to form the first rear cavity B1 in cooperation with the first diaphragm 3, and a second cover body Z2 may be disposed on the dual-diaphragm speaker to form the second front cavity F2 with the second diaphragm 5. The following uses the another dual-diaphragm speaker in the first embodiment shown in FIG. 11 to FIG. 13 as an example for description.

FIG. 16 is a top view of the another dual-diaphragm speaker shown in FIG. 11 on which a cover body is disposed. FIG. 17 is a schematic diagram of a sectional view structure along an N-N line in FIG. 16. As shown in FIG. 16 and FIG. 17, the dual-diaphragm speaker may further include a first cover body Z1 and a second cover body Z2. The first cover body Z1 is in a sealed connection to the first diaphragm 3 as the first component, to form the first rear cavity B1. The second cover body Z2 is in a sealed connection to the second diaphragm 5 as the second component, to form the second front cavity F2, and the first front cavity F1 of the dual-diaphragm speaker communicates with the second front cavity F2 through the first channel 1. In this case, the electronic device on which the dual-diaphragm speaker is mounted may include a sound output pipe, and the second front cavity F2 of the dual-diaphragm speaker communicates with the sound output pipe.

In an example, on the another dual-diaphragm speaker of the first embodiment shown in FIG. 11 to FIG. 13, only the second cover body Z2 may be disposed, and the second cover body Z2 is in the sealed connection to the second diaphragm 5 as the second component, to form the second front cavity F2. The first front cavity F1 communicates with the second front cavity F2 through the first channel P1. The first component is the first structure 10 of the electronic device on which the dual-diaphragm speaker is mounted. In other words, the electronic device on which the dual-diaphragm speaker is mounted may include the first structure 10 and the sound output pipe, and the first structure 10 is connected to the first diaphragm 3 on the side surface that is of the first diaphragm 3 of the dual-diaphragm speaker and that is away from the magnetic circuit system 2, to form the first rear cavity B1. The second front cavity F2 of the dual-diaphragm speaker is connected to the sound output pipe of the electronic device.

In another example, in the another dual-diaphragm speaker of the first embodiment shown in FIG. 11 to FIG. 13, only the first cover body Z1 may be disposed, and the first cover body Z1 is in a sealed connection to the first diaphragm 3 on the side surface that is of the first diaphragm 3 and that is away from the magnetic circuit system 2, to form the first rear cavity B1. In this case, the second component is the sound output pipe of the electronic device. In other words, the electronic device on which the dual-diaphragm speaker is mounted may include the sound output pipe 20, and the sound output pipe 20 is connected to the second diaphragm 5 on the side surface that is of the second diaphragm 5 of the dual-diaphragm speaker and that is away from the magnetic circuit system 2, to form the second rear cavity F2. The first front cavity F1 and the second front cavity F2 of the dual-diaphragm speaker are connected through the first channel P1 on the dual-diaphragm speaker.

In other words, when no cover body is disposed on the dual-diaphragm speaker in an embodiment of the application, the two diaphragms of the dual-diaphragm speaker may cooperate with the structure of the electronic device to form the first rear cavity and the second front cavity. Because the cover body does not need to be disposed, space can be saved. This helps further reduce a volume of the electronic device or use the space for another structure, such as using a larger battery, to improve a battery life. When the first cover body Z1 and/or the second cover body Z2 are/is disposed on the dual-diaphragm speaker in an embodiment of the application, a corresponding structure of the electronic device on which the dual-diaphragm speaker is mounted does not need to be improved to form the first rear cavity and/or the second front cavity with the diaphragm of the dual-diaphragm speaker, and the structure of the electronic device is slightly improved.

In conclusion, according to the dual-diaphragm speaker in embodiments of this application, the sound wave transfer paths of the front cavities and the rear cavities of the two diaphragms are respectively separated, so that the sound short circuit is avoided and the two diaphragms can vibrate in the same direction to make the sound. The cavity channel is formed by using the magnetic circuit system and the ring-shaped housing, so that the sound pressure superimposition effect is implemented and the low and medium frequencies are enhanced, thereby improving the low- and medium-frequency sensitivity of the speaker, improving the ANC performance in the semi-open architecture, and enhancing the low and medium frequencies of the target signal. In addition, the dual-diaphragm speaker has the features such as the wide high-frequency bandwidth and the small occupied space, and can improve the sound quality and reduce the volume, which helps improve user experience.

A TWS earphone module cannot consider high-frequency extension for low- and medium-frequency noise canceling performance. A plurality of units are required, but encapsulation of the plurality of units takes up too much stacking space and a magnetic circuit utilization is also low. According to the speaker in embodiments of this application, a closed magnetic loop in which magnetic circuits of two speaker units are mutually enhanced and circulated is constructed and a dual vibration system and an independent front cavity and rear cavity are combined. Therefore, the magnetic circuit utilization is improved, the volume is reduced, and the area of the diaphragm is increased, so that speaker sensitivity can be improved and frequency bandwidth can be extended.

The dual-diaphragm speaker in embodiments of this application has the advantages such as the high low- and medium-frequency sensitivity and the small volume, may be applied to a portable electronic device such as a small earphone, and may be applied to a speaker of an audio product, to implement playing of a music signal, support achievement of aims of high sensitivity and wide high-frequency bandwidth, and provide high-quality music experience. Specifically, two PAs of the TWS earphone may separately drive two diaphragms of the speaker, perform digital frequency division, and can be configured to implement effect such as TWS active noise canceling, Hi-Fi music playing, transparent transmission, and 3D sound effect. In an example, the dual-diaphragm speaker in embodiments of this application can improve low-frequency sensitivity by 8 dB compared with an existing single-diaphragm speaker, and compared with an existing dual-diaphragm speaker, can improve the low-frequency sensitivity by 10 dB. The channel connecting the two front cavities is disposed inside the ring-shaped housing, and an additional pipeline does not need to be disposed to connect the two front cavities. In addition, a magnetic circuit is shared, so that an overall thickness can be reduced, and the volume can be reduced by 32%.

It should be noted that the foregoing embodiments are merely intended for describing the technical solutions of this application, but not for limiting this application. Although this application is described in detail with reference to the foregoing embodiments, one of ordinary skilled in the art should understand that modifications may still be made to the technical solutions described in the foregoing embodiments or equivalent replacements may be made to some technical features thereof, without departing from the scope of the technical solutions of embodiments of this application.

1. An electronic device having a dual-diaphragm speaker, comprising:
a ring-shaped housing;
a magnetic circuit system, disposed in the ring-shaped housing and dividing space in the ring-shaped housing into a first cavity and a second cavity in a direction of a principal axis of the ring-shaped housing, wherein the magnetic circuit system comprises a first magnetic gap and a second magnetic gap disposed at a spacing around the principal axis;
a first diaphragm, disposed at a first end of the ring-shaped housing, to form a first front cavity with the first cavity, and configured to form a first rear cavity with a first component on a side surface that is of the first diaphragm away from the magnetic circuit system;
a first voice coil, disposed in the first front cavity, wherein one end of the first voice coil is connected to the first diaphragm, and the other end of the first voice coil extends into the first magnetic gap;
a second diaphragm, disposed at a second end of the ring-shaped housing, to form a second rear cavity with the second cavity, and configured to form a second front cavity with a second component on a side surface of the second diaphragm away from the magnetic circuit system, wherein the second rear cavity is not in communication with the first front cavity; and
a second voice coil, disposed in the second rear cavity, wherein one end of the second voice coil is connected to the second diaphragm, and the other end of the second voice coil extends into the second magnetic gap, wherein
the first front cavity communicates with the second front cavity through at least one first channel, and a first channel is located in at least one of the magnetic circuit system and the ring-shaped housing; and
the second rear cavity is closed, or the second rear cavity communicates with the first rear cavity or the atmosphere through at least one second channel.

2. The electronic device according to claim 1, wherein an outer peripheral wall of the magnetic circuit system is in a sealed connection to an inner wall of the ring-shaped housing, an outer peripheral edge of the second diaphragm is in a sealed connection to the magnetic circuit system, and the first channel comprises a first opening groove disposed on the inner wall of the ring-shaped housing and/or on the outer peripheral wall of the magnetic circuit system; and
the first diaphragm is in a sealed connection to an entire end surface of the first end of the ring-shaped housing, and the first opening groove extends from the first front cavity to an end surface of the second end of the ring-shaped housing; or
the first diaphragm is in a sealed connection to the magnetic circuit system, a first notch communicating with the first front cavity is disposed on the magnetic circuit system, the first channel further comprises the first notch, and the first opening groove extends from the first notch to an end surface of the second end of the ring-shaped housing.

3. The electronic device according to claim 2, wherein the second rear cavity communicates with the first rear cavity or the atmosphere through a second channel, and a second notch communicating with the second rear cavity is disposed on the magnetic circuit system; and
the second channel comprises a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or
the first diaphragm is in a sealed connection to the magnetic circuit system, the second channel comprises the second notch and the second opening groove disposed on the inner wall of the ring-shaped housing and/or on the outer peripheral wall of the magnetic circuit system, and the second opening groove extends from the second notch to an end surface of the first end of the ring-shaped housing.

4. The electronic device according to claim 1, wherein a first ring-shaped boss is disposed on an inner wall of the first end of the ring-shaped housing, the first diaphragm is in a sealed connection to the first ring-shaped boss, the magnetic circuit system is connected to a side surface that is of the first ring-shaped boss away from the first diaphragm, an outer peripheral wall of the magnetic circuit system is in a sealed connection to an inner wall of the ring-shaped housing, an outer peripheral edge of the second diaphragm is in a sealed connection to the magnetic circuit system, a first notch communicating with the first front cavity is disposed on at least one of the first ring-shaped boss and the magnetic circuit system, the first channel comprises the first notch and a first opening groove disposed on the inner wall of the ring-shaped housing and/or on the outer peripheral wall of the magnetic circuit system, and the first opening groove extends from the first notch to an end surface of the second end of the ring-shaped housing.

5. The electronic device according to claim 4, wherein the second rear cavity communicates with the first rear cavity or the atmosphere through the second channel, and a second notch communicating with the second rear cavity is disposed on the magnetic circuit system; and
the second channel comprises a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or
the second channel comprises the second notch and the second opening groove disposed on the inner wall of the ring-shaped housing and/or on the outer peripheral wall of the magnetic circuit system, and the second opening groove extends from the second notch to an end surface of the first end of the ring-shaped housing and penetrates the first ring-shaped boss.

6. The electronic device according to claim 1, wherein a second ring-shaped boss is disposed on an inner wall of the second end of the ring-shaped housing, the second diaphragm is in a sealed connection to the second ring-shaped boss, the magnetic circuit system is connected to a side surface of the second ring-shaped boss away from the second diaphragm, and the first channel comprises a first opening groove disposed on an inner wall of the ring-shaped housing and/or on an outer peripheral wall of the magnetic circuit system; and
the first diaphragm is in a sealed connection to an entire end surface of the first end of the ring-shaped housing, and the first opening groove extends from the first front cavity to an end surface of the second end of the ring-shaped housing and penetrates the second ring-shaped boss; or
the first diaphragm is in a sealed connection to the magnetic circuit system, a first notch communicating with the first front cavity is disposed on the magnetic circuit system, the first channel further comprises the first notch, and the first opening groove extends from the first notch to an end surface of the second end of the ring-shaped housing.

7. The electronic device according to claim 6,
wherein the second rear cavity communicates with the first rear cavity or the atmosphere through the second channel, and a second notch communicating with the second rear cavity is disposed on at least one of the second ring-shaped boss and the magnetic circuit system; and
the second channel comprises a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or
the first diaphragm is in a sealed connection to the magnetic circuit system, the second channel comprises the second notch and the second opening groove disposed on the inner wall of the ring-shaped housing and/or on the outer peripheral wall of the magnetic circuit system, and the second opening groove extends from the second notch to an end surface of the first end of the ring-shaped housing.

8. The electronic device according to claim 1, wherein a first ring-shaped boss is disposed on an inner wall of the first end of the ring-shaped housing, a second ring-shaped boss is disposed on an inner wall of the second end of the ring-shaped housing, the magnetic circuit system is connected between the first ring-shaped boss and the second ring-shaped boss, an outer peripheral wall of the magnetic circuit system is in a sealed connection to an inner wall of the ring-shaped housing, an outer peripheral edge of the first diaphragm is in a sealed connection to the first ring-shaped boss, and an outer peripheral edge of the second diaphragm is in a sealed connection to the second ring-shaped boss; and
a first notch communicating with the first front cavity is disposed on at least one of the first ring-shaped boss and the magnetic circuit system, the first channel comprises the first notch and a first opening groove disposed on the inner wall of the ring-shaped housing and/or on the outer peripheral wall of the magnetic circuit system, and the first opening groove extends from the first notch to an end surface of the second end of the ring-shaped housing and penetrates the second ring-shaped boss.

9. The electronic device according to claim 8, wherein the second rear cavity communicates with the first rear cavity or the atmosphere through the second channel, and a second notch communicating with the second rear cavity is disposed on at least one of the second ring-shaped boss and the magnetic circuit system; and
the second channel comprises a second port, the second notch, and a second opening groove disposed on the inner wall of the ring-shaped housing and/or on the outer peripheral wall of the magnetic circuit system, the second port is disposed on an outer peripheral wall of the ring-shaped housing, and the second opening groove extends from the second notch to the second port; or
the second channel comprises the second notch and the second opening groove disposed on the inner wall of the ring-shaped housing and/or on the outer peripheral wall of the magnetic circuit system, and the second opening groove extends from the second notch to an end surface of the first end of the ring-shaped housing and penetrates the first ring-shaped boss.

10. The electronic device according to claim 1, wherein an outer peripheral wall of the magnetic circuit system is in a sealed connection to an inner peripheral wall of the ring-shaped housing, the first channel comprises a first through hole disposed on the magnetic circuit system or the ring-shaped housing, and one end of the first through hole is connected to the first front cavity, and the other end of the first through hole extends to an end surface of the second end of the ring-shaped housing.

11. The electronic device according to claim 1, wherein the second rear cavity communicates with the first rear cavity or the atmosphere through the second channel, the outer peripheral wall of the magnetic circuit system is in a sealed connection to the inner peripheral wall of the ring-shaped housing, the second channel comprises a second through hole disposed on the magnetic circuit system or the ring-shaped housing, and a first end of the second through hole communicates with the second rear cavity, and the other end of the second through hole extends to the end surface of the first end of the ring-shaped housing or to an outer peripheral wall of the ring-shaped housing.

12. The electronic device according to claim 10, wherein
the first ring-shaped boss is disposed on the inner wall of the first end of the ring-shaped housing, and the magnetic circuit system is in a sealed connection to the first ring-shaped boss on the side surface of the first ring-shaped boss away from the first diaphragm; and/or
the second ring-shaped boss is disposed on the inner wall of the second end of the ring-shaped housing, and the magnetic circuit system is in a sealed connection to the second ring-shaped boss on the side surface of the second ring-shaped boss away from the second diaphragm.

13. The electronic device according to claim 1, wherein more than two first channels are disposed in the dual-diaphragm speaker, and the more than two first channels are disposed at a spacing in a circumferential direction of the ring-shaped housing.

14. The electronic device according to claim 1, wherein more than two second channels are disposed in the dual-diaphragm speaker, and the more than two second channels are disposed at a spacing in a circumferential direction of the ring-shaped housing.

15. The electronic device according to claim 1, wherein a positioning boss is disposed on an outer peripheral wall of the ring-shaped housing, a plurality of through holes communicating with an inner side and an outer side of the ring-shaped housing are disposed on the positioning boss, a first voice coil line is disposed on the first voice coil, a second voice coil line is disposed on the second voice coil, the first voice coil line and the second voice coil line are respectively electrically connected to a power amplifier apparatus through the plurality of through holes, and the positioning boss and the at least one first channel or the at least one second channel are disposed at a spacing in a circumferential direction of the ring-shaped housing.

16. The electronic device according to claim 1, wherein the ring-shaped housing comprises a first housing and a second housing disposed in the direction of the principal axis; and
a first ring-shaped step is disposed on an end surface of an end of the first housing away from the second housing, a first ring-shaped mounting part is disposed on the outer peripheral edge of the first diaphragm, and the first ring-shaped mounting part is disposed at the first ring-shaped step, to implement a sealed connection between the outer peripheral edge of the first diaphragm and the end surface of the first end of the ring-shaped housing; and/or
a second ring-shaped step is disposed on an end surface of an end of the second housing away from the first housing, a second ring-shaped mounting part is disposed on the outer peripheral edge of the second diaphragm, and the second ring-shaped mounting part is disposed at the second ring-shaped step, to implement a sealed connection between the outer peripheral edge of the second diaphragm and the end surface of the second end of the ring-shaped housing.

17. The electronic device according to claim 1, wherein when the first voice coil and the second voice coil are connected to an alternating current, vibration directions of the first diaphragm and the second diaphragm are the same.

18. The electronic device according to claim 1, wherein the first component is a first structure of an electronic device on which the dual-diaphragm speaker is mounted, and the second component is a sound output pipe of the electronic device.

19. The electronic device according to claim 1, further comprising:
a first cover body in a sealed connection to the first diaphragm as the first component, to form the first rear cavity; and
a second cover body in a sealed connection to the second diaphragm as the second component, to form the second front cavity, and the second front cavity is configured to communicate with a sound output pipe of an electronic device.

20. The electronic device according to claim 1, wherein the first component is the first structure of the electronic device on which the dual-diaphragm speaker is mounted, and the dual-diaphragm speaker further comprises:
a second cover body in a sealed connection to the second diaphragm as the second component, to form the second front cavity, and the second front cavity is configured to communicate with a sound output pipe of the electronic device.

21.-25. (canceled)
